(19) United States
(12) Patent Application Publication
(10) Pub. No.: US 2017/0054646 A1
(43) Pub. Date: Feb. 23, 2017

(54) BANDWIDTH CONTROL DEVICE AND BANDWIDTH CONTROL METHOD

(71) Applicant: FUJITSU LIMITED, Kawasaki-shi (JP)

(72) Inventor: Atsushi Kitada, Kawasaki (JP)

(73) Assignee: FUJITSU LIMITED, Kawasaki-shi (JP)

(21) Appl. No.: 15/230,892

(22) Filed: Aug. 8, 2016

(30) Foreign Application Priority Data
Aug. 20, 2015 (JP) 2015-163186

(51) Int. Cl. H04L 12/823; H04L 12/819

(52) U.S. Cl. CPC H04L 47/32; H04L 47/215

(57) ABSTRACT

There is provided a bandwidth control device including a token controller configured to supply tokens of packets according to requests; a pass controller configured to request the tokens of the token controller for each flow of packets, and control passage of the packets for each of flows based on an accumulation amount of the tokens supplied according to the requests; and a priority controller configured to control priority of the requests to the token controller according to comparison results of an input rate of the packets for each of the flows with a predetermined value set for each of the flows.

### CROSS-REFERENCE TO RELATED APPLICATION

This application is based upon and claims the benefit of priority of the prior Japanese Patent Application No. 2015-163186, filed on Aug. 20, 2015, the entire contents of which are incorporated herein by reference.

### FIELD

The embodiments discussed herein relate to a bandwidth control device and a bandwidth control method.

### BACKGROUND

There is a case in which a communication device such as a router or a layer 2 switch is provided with a policer for controlling the rate of input packets. The policer allows packets to pass through by consuming a token which is supplied in a token packet, and discards the packets in a case in which the token is insufficient, and thus, controls the bandwidth of input packets on a per-flow basis.

The flows of packets are identified by a virtual local area network (VLAN) Identifier (VID), a multi-protocol label switching (MPLS) label, or the like of the packets. The token supply rate of each policer is determined according to a bandwidth which a user agrees for each flow. Japanese Laid-open Patent Publication No. 2001-345849 discloses a router which determines whether or not a transmission rate of a user exceeds an agreed bandwidth.

For example, the metro ethernet forum (MEF) stipulates a policing algorithm which supplies excess tokens of one flow to another flow. According to the algorithm, for example, in a case in which an audio signal flow and a data signal flow are present, it is possible to use an excess portion of the bandwidth allocated to the audio signal to pass the data signal.

For example, in a case in which the bandwidth of the audio signal is 5 Mbps and the bandwidth of the data signal is 10 Mbps, if there is only 3 Mbps of audio signal flow, it is possible to allow up to 12 Mbps (=10+2) of data signal flow. In the actual policing process, when a token is added to a token packet of a higher order policer, the excess portion of the token is added to the token packet of a lower order policer.

Japanese Laid-open Patent Publication No. 2013-197823 discloses a distributed policing method relating to the above-described algorithm. Main buckets and mini buckets are used in distributed policing. Tokens are supplied to the main buckets according to the agreed bandwidth of the user, tokens are accumulated in the mini buckets for each flow, and the tokens are supplied from the main buckets to the mini buckets of each flow.

Thresholds are set for the mini buckets, and in a case in which the accumulation amount of the tokens falls below the threshold, a request for tokens is sent to the main buckets. Since there is a case in which a plurality of the mini buckets request tokens at the same time, a waiting buffer which holds requests is used such that, even in low speed processing by software or the like, the tokens are supplied correctly.

The waiting buffer is provided with an ordinary queue and an urgent queue. The ordinary queue holds requests which are made when the accumulation amount of the tokens falls below the threshold, and the urgent queue holds requests which are made when the accumulation amount of the tokens falls below a lower threshold than the threshold described above. The tokens are supplied from the main buckets according to the requests in the emergency queue with priority over the requests in the ordinary queue. Accordingly, the tokens are preferentially supplied to the mini buckets which appear to be almost depleted of tokens.

### SUMMARY

According to an aspect of the invention, a bandwidth control device includes: a token controller configured to supply tokens of packets according to requests; a pass controller configured to request the tokens of the token controller for each flow of packets, and control passage of the packets for each of flows based on an accumulation amount of the tokens supplied according to the requests; and a priority controller configured to control priority of the requests to the token controller according to comparison results of an input rate of the packets for each of the flows with a predetermined value set for each of the flows.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a configuration diagram illustrating an example of a communication device;

FIG. 2 is a configuration diagram illustrating an example of the functional configuration of an interface card;

FIG. 3 is a diagram illustrating an operational example of a policer of a comparative embodiment in an ordinary state;

FIG. 4 is a diagram illustrating an operational example of a policer of a comparative embodiment in an abnormal state;

FIG. 5 is a configuration diagram illustrating an example of a policer of embodiments;

FIG. 6 is a flowchart illustrating an example of the operations of a pass controller;

FIG. 7A is a graph illustrating an example of the change in token accumulation amount;

FIG. 7B is a diagram illustrating an example of a rate monitoring table;

FIG. 8 is a diagram illustrating an example of the operations of the policer when the token accumulation amount falls below a first threshold;

FIG. 9A is a diagram illustrating an example of the operations of the policer when the token accumulation amount falls below a second threshold in a case in which input rate>agreed rate;

FIG. 9B is a diagram illustrating an example of the operations of the policer when the token accumulation amount falls below the second threshold in a case in which input rate≦agreed rate;

FIG. 10A is a diagram illustrating an output example of an ordinary request message;

FIG. 10B is a diagram illustrating an output example of an urgent request message;

FIG. 11 is a flowchart illustrating an example of the operations of a request determination unit;

FIG. 12A is a diagram illustrating an example of the rate monitoring table prior to updating;

FIG. 12B is a diagram illustrating an example of the rate monitoring table after updating;

FIG. 13 is a flowchart illustrating another example of the operations of the request determination unit;

FIG. 14A is a diagram illustrating another example of a rate monitoring table;

FIG. 14B is a diagram illustrating an example of the operations of the policer when the token accumulation amount falls below the second threshold in a case in which a number of periods in which packets are discarded≦an upper limit number;

FIG. 14C is a diagram illustrating an example of the operations of the policer when the token accumulation amount falls below the second threshold in a case in which the number of periods in which packets are discarded>an upper limit number;

FIG. 15 is a flowchart illustrating an example of the updating process of the rate monitoring table;

FIG. 16 is a flowchart illustrating another example of the operations of the request determination unit;

FIG. 17A is a diagram illustrating the operations of a priority controller of another example in a case in which an ordinary request message is input;

FIG. 17B is a diagram illustrating the operations of a priority controller of another example in a case in which an urgent request message of a flow in which input rate≦agreed rate is input;

FIG. 17C is a diagram illustrating the operations of a priority controller of another example in a case in which an urgent request message of a flow in which input rate>agreed rate is input;

FIG. 18 is a flowchart illustrating another example of the operations of the request determination unit;

FIG. 19A is a diagram illustrating the operations of a priority controller of another example in a case in which an ordinary request message is input;

FIG. 19B is a diagram illustrating the operations of a priority controller of another example in a case in which an urgent request message of a flow in which input rate≦agreed rate/2 is input;

FIG. 19C is a diagram illustrating the operations of a priority controller of another example in a case in which an urgent request message of a flow in which agreed rate/2<input rate≦agreed rate is input;

FIG. 20A is a diagram illustrating the operations of a priority controller of another example in a case in which an urgent request message of a flow in which agreed rate<input rate≦2×agreed rate is input;

FIG. 20B is a diagram illustrating the operations of a priority controller of another example in a case in which an urgent request message of a flow in which 2×agreed rate<input rate is input;

FIG. 21 is a flowchart illustrating another example of the operations of the request determination unit; and

FIG. 22 is a diagram illustrating the effects of the policer of the embodiments.

### DESCRIPTION OF EMBODIMENTS

A consumption amount of tokens depends not only on the output rate of the packets, but also on the input rate. Therefore, in a case in which the input rate exceeds the agreed bandwidth rate, only the output rate of the agreed bandwidth is secured while using up the tokens. The packets in excess of the agreed bandwidth are discarded.

Therefore, in a case in which there are multiple flows in which the input rate exceeds the agreed bandwidth rate, the urgent queue which is not ordinarily congested becomes congested due to the multiple requests for the tokens. Therefore, in a case in which the accumulation amount of the tokens of a flow in which the input rate is less than or equal to the agreed bandwidth rate appears to be almost depleted, even if the tokens are requested, the tokens are not supplied in time, and packets are discarded. Therefore, there is a case in which the agreed bandwidth is not guaranteed for a flow in which the input rate is less than or equal to the agreed bandwidth rate.

Hereinafter, using the drawings, description will be given of the technique of the bandwidth control device and the bandwidth control method which improves the performance of the bandwidth guarantee.

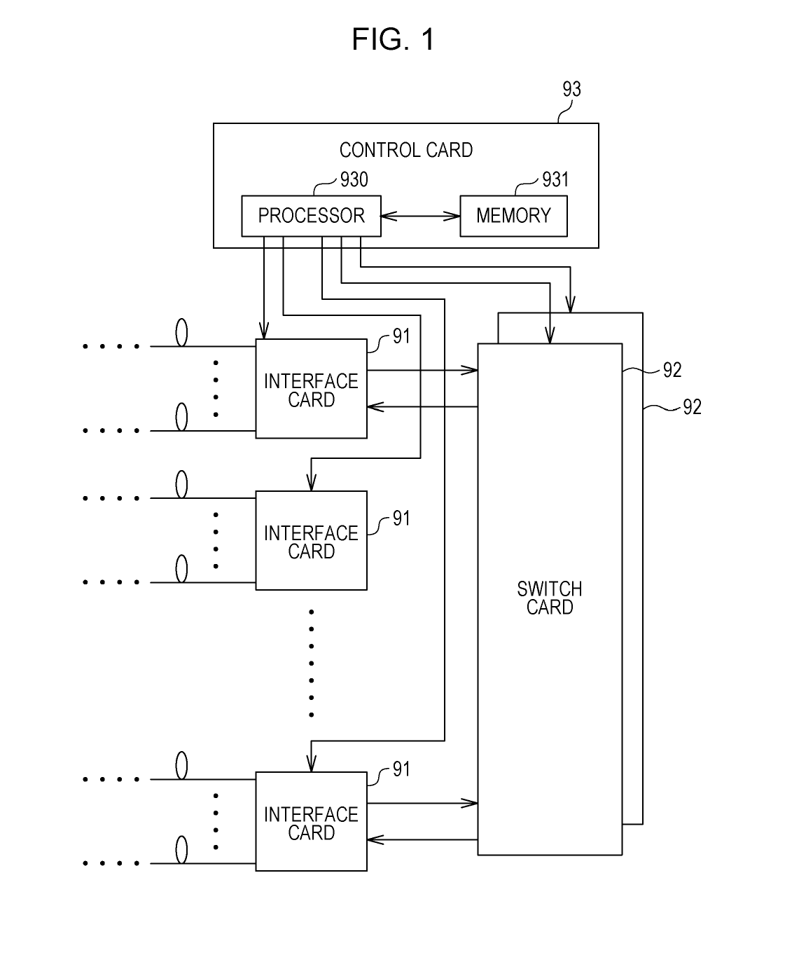

FIG. 1 is a configuration diagram illustrating an example of a communication device. The communication device includes a plurality of interface cards 91, two switch cards 92, and a control card 93. Each of the cards 91 to 93 is stored in an individual slot provided in a housing, and the cards 91 to 93 are electrically connected to each other. In the present specification, a layer 2 switch and a router are exemplified as communication devices in which a bandwidth control device of the embodiments is installed; however, the configuration is not limited thereto, and the bandwidth control device of the example is also installed in other communication devices such as a wavelength multiplex transmission device.

The communication device relays the packets which are received from another device to another device according to the destination. In the present specification, a packet is a transmission unit (protocol data unit (PDU) of transmitted data (information), and an Ethernet (registered trademark, same hereinafter) frame is an example of a packet; however, the configuration is not limited thereto, and another PDU such as an Internet protocol (IP) packet may be used.

Each of the interface cards 91 transmits and receives packets to and from another device. Examples of the other device include a terminal device such as a personal computer, a server, and a router. The interface card 91 is connected to fiber optic cable through a plurality of ports, and performs communication based on the 10 GBASE-LR standard, for example.

Each of the two switch cards 92 exchanges packets with a plurality of the interface cards 91. More specifically, the switch card 92 receives input of a packet from the interface card 91, and outputs the packet to the interface card 91 corresponding to the destination. The two switch cards 92 are used as a current-use system and a spare system in preparation for issues such as hardware problems.

The control card 93 controls the plurality of interface cards 91 and the two switch cards 92. The control card 93 is connected to a network control device or the like, and performs processes relating to the user interface, the setting processes of each of the cards 91 and 92, information gathering processes from each of the cards 91 and 92, and the like. The control card 93 includes a processor 930 such as a central processing unit (CPU) which executes the processes, and a memory 931 which stores programs which drive the processor 930.

As described later, main buckets to which tokens are supplied according to a predetermined algorithm may be installed in the control card 93 as described later. The tokens accumulated in the main buckets are supplied to the mini buckets which are provided in each of the interface cards 91 according to requests. This function is realized by the processor 930, for example, using network functions virtualization (NFV), that is, the function is realized using software.

However, it is difficult to realize bandwidth control processing of traffic which exceeds 100 Gbps using the processor 930 from the perspective of processing speed. Therefore, it is preferable to distribute the bandwidth control processing using the mini buckets to the hardware within the interface cards 91. The bandwidth control processing is not limited thereto, and may be entirely realized by the interface cards 91.

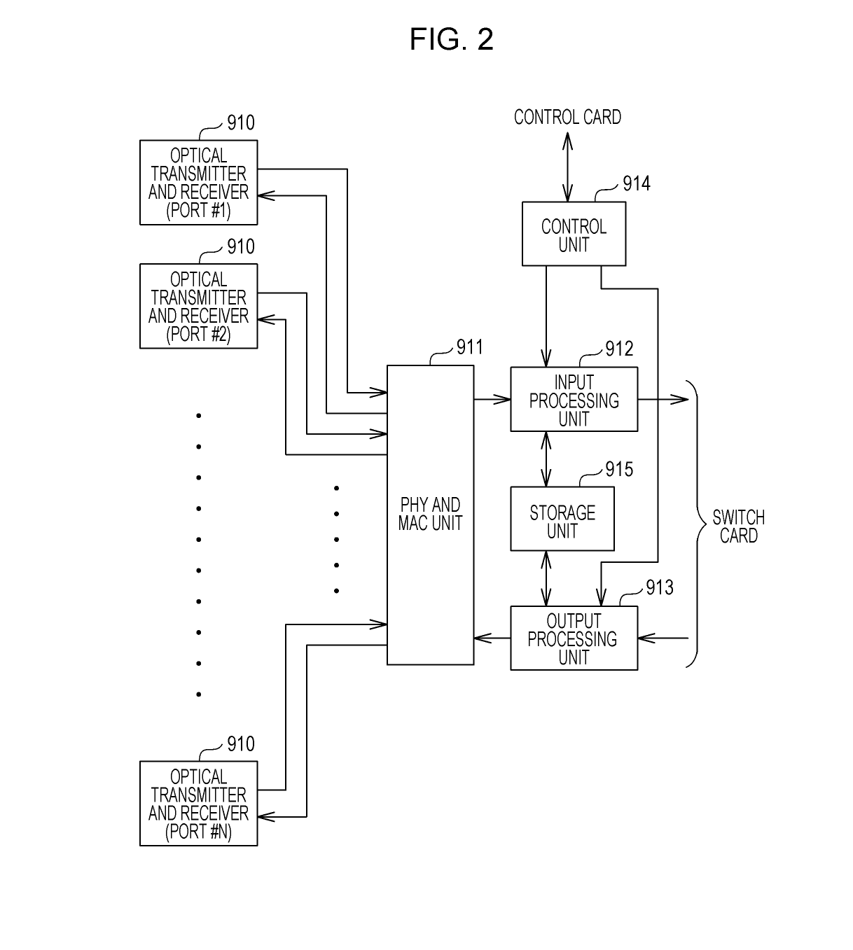

FIG. 2 is a configuration diagram illustrating the functional configuration of the interface card 91. The interface card 91 includes a plurality of optical transmitter and receivers 910, a PHY and MAC unit 911, an input processing unit 912, an output processing unit 913, a control unit 914, and a storage unit 915.

Each of the plurality of optical transmitter and receivers 910 converts an optical signal which is received via an optical fiber from another device into an electrical signal and outputs the electrical signal to the PHY and MAC unit 911, and converts an electrical signal which is input from the PHY and MAC unit 911 into an optical signal and transmits the optical signal to another device via optical fiber. In other words, the plurality of optical transmitter and receivers 910 function as a plurality of ports #1 to #N (N: a positive integer) for transmitting and receiving packets between the port and another device.

The PHY and MAC unit 911 performs a link establishment process with another device, a packet distribution process of the packets in relation to the plurality of optical transmitter and receivers 910, and the like. The PHY and MAC unit 911 outputs the packets which are input from the plurality of optical transmitter and receivers 910 to the input processing unit 912, and outputs the packets which are input from the output processing unit 913 to the plurality of optical transmitter and receivers 910.

The input processing unit 912 and the output processing unit 913 are logical circuits such as a field programmable gate array (FPGA) or an application specific integrated circuit (ASIC), and perform ingress filtering and egress filtering, respectively. The input processing unit 912 performs the bandwidth control processing of the packets which are input from the PHY and MAC unit 911 and outputs the packets to the switch card 92.

The output processing unit 913 performs the transmission rate control processing of the packets which are input from the switch card 92 and outputs the packets to the PHY and MAC unit 911. The storage unit 915 is storage such as memory, and stores various data which is used by the input processing unit 912 and the output processing unit 913.

The control unit 914 communicates with the control card 93 and controls the input processing unit 912 and the output processing unit 913. The control unit 914 is provided with a processor such as a CPU and a memory (not illustrated). Examples of processes of the control unit 914 include various setting processes of the input processing unit 912 and the output processing unit 913, and collection processes of warnings which are detected on the input processing unit 912 and the output processing unit 913. A portion of the bandwidth control processing may be realized using software processing of the control unit 914.

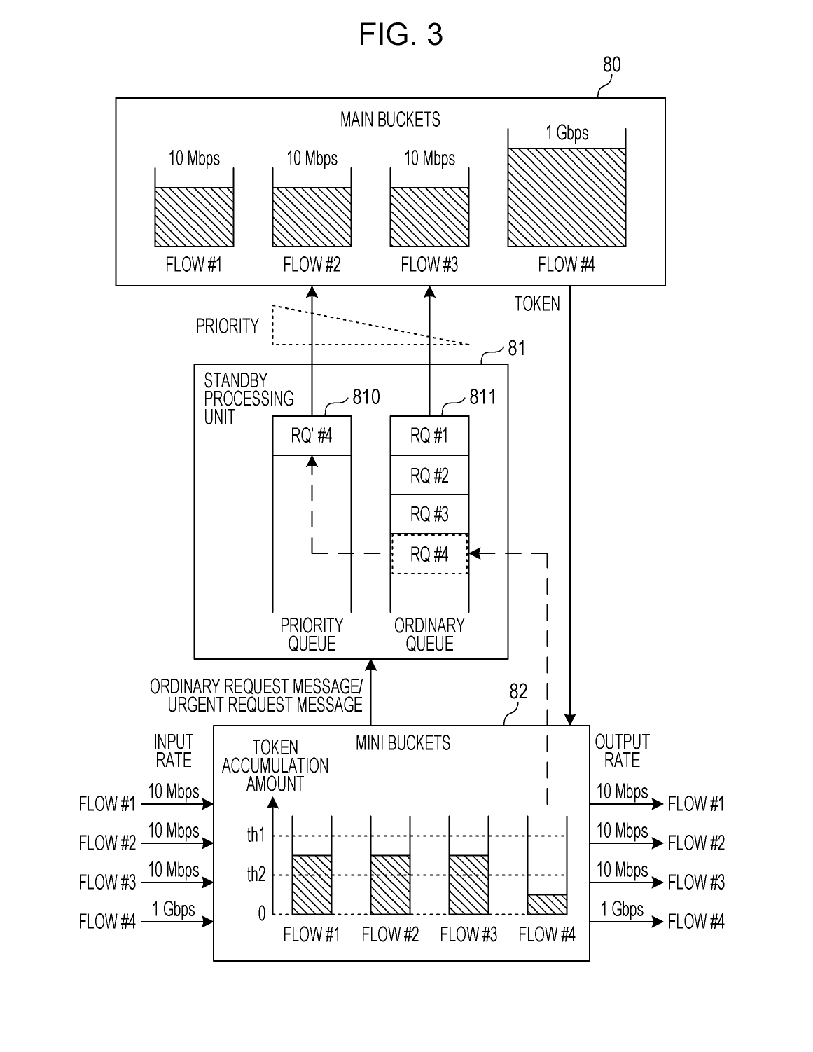

FIG. 3 illustrates an operational example of a policer of a comparative embodiment in an ordinary state. The policer is an example of a bandwidth control device, and performs bandwidth controls of the packets which are input for each flow. The present comparative embodiment is, for example, based on the dispersed policing method disclosed in Japanese Laid-open Patent Publication No. 2013-197823.

In a case in which the configuration is simplified, the policer includes main buckets 80, a standby processing unit 81, and mini buckets 82. In the main buckets 80, for example, the tokens are added at a rate (hereinafter denoted as “agreed rate”) corresponding to an agreed bandwidth of the user for each of flows #1 to #4. In the present example, tokens are added at a rate of 10 Mbps in the flows #1 to #3, and tokens are added at a rate of 1 Gbps in flow #4. The amount of tokens is represented by the amount of data allowed to pass (allowable passage amount), and there is no limit to the algorithm for adding the tokens.

Since a high processing speed is not demanded of the main buckets 80, the main buckets 80 are realized using software processing of the processor 930 of the control card 93, for example. Therefore, it is possible to flexibly customize the algorithm of adding the tokens by changing the software. The tokens of the main buckets 80 are supplied to the mini buckets 82 according to requests.

The mini buckets 82 are provided for each of the flows #1 to #4. In a case in which the token accumulation amount in the mini buckets 82 is greater than 0, the packets of each of the flows #1 to #4 are passed by the policer, and in a case in which the token accumulation amount is less than or equal to 0, the packets are discarded. Accordingly, the input bandwidth is controlled for each of the flows #1 to #4.

The function of pass control is common in the policer, and since there is demand for high processing speed corresponding to the input rate of the packers, the function may be configured using hardware. The mini buckets 82 are provided in the input processing unit 912 of the interface card 91, for example.

In the present example, the input rate of the packets of each of the flows #1 to #4 is assumed to be the same as the agreed rate. More specifically, the input rate of the flows #1 to #3 is 10 Mbps, and the input rate of the flow #4 is 1 Gbps.

Therefore, sufficient tokens are supplied to the mini buckets 82 of each of the flows #1 to #4 from the main buckets 80 in relation to the input rate. Accordingly, as described below, an output rate of 10 Mbps is secured in the flows #1 to #3, and an output rate of 1 Gbps is secured in the flow #4.

Thresholds are set for the mini buckets 82, and in a case in which the token accumulation amount falls below the threshold, a request for tokens is sent to the main buckets 80. When tokens are requested from a plurality of the mini buckets 82 at the same time, the supply of the tokens may be delayed due to a difference in the processing speeds of hardware and software. Therefore, the hardware, that is, the input processing unit 912 is provided with the standby processing unit 81 which holds the requests for tokens and waits.

However, of the flows #1 to #4, since the speed at which the tokens are depleted is faster in the flow #4, which has a high output rate, than the other flows #1 to #3, in a case in which the requests become congested in the standby processing unit 81, there is a concern that the tokens will not be supplied in time for the passage of the packets. Naturally, if only the packets of the flows #1 to #3 which have low output rates are passed, for example, it is possible to supply the tokens in time by adjusting the threshold of the mini buckets 82 and the supply amount of the tokens from the main buckets 80. However, as in the present example, it is more realistic to use the flow #4 with the high output rate and the flows #1 to #3 with the low output rate together.

A first threshold th1 and a second threshold th2 which is lower than the first threshold th1 are set in the mini buckets 82, and in addition, a priority queue 810 and an ordinary queue 811 having different priorities are provided in the standby processing unit 81. In a case in which the token accumulation amount falls below the first threshold th1, the ordinary request message is output and is input to the ordinary queue 811. Meanwhile, in a case in which the token accumulation amount falls below the second threshold th2, the urgent request message is output and is input to the priority queue 810.

In the example of FIG. 3, the token accumulation amount of the flows #1 to #3 falls below the first threshold th1, and ordinary request messages RQ#1 to RQ#3 are output and stored in the ordinary queue 811. Subsequently, the token accumulation amount of flow #4 with the high output rate falls below the first threshold th1, and an ordinary request message RQ#4 is output and stored in the ordinary queue 811. At this time, since the ordinary request messages RQ#1 to RQ#3 of the flows #1 to #3 precede the ordinary request message RQ#4 of the flow #4, the ordinary request message RQ#4 of the flow #4 is stored at the end of the ordinary queue 811, and the token supply to the mini buckets 82 of the flow #4 is performed after that of the flows #1 to #3.

However, since the output rate of the flow #4 is higher than that of the other flows #1 to #3, the depletion of tokens is fast. Therefore, the token accumulation amount in the mini buckets 82 of the flow #4 quickly falls below the second threshold th2, and an urgent request message RQ′#4 is output. The urgent request message RQ′#4 is input to the priority queue 810, and the ordinary request message RQ#4 which is stored in the ordinary queue 811 is deleted (refer to the dotted line).

Since the priority of the priority queue 810 is higher than that of the ordinary queue 811, the urgent request message RQ′#4 in the priority queue 810 is output to the main buckets 80 before the ordinary request messages RQ#1 to RQ#3 in the ordinary queue 811. Accordingly, the token is supplied from the main buckets 80 to the mini buckets 82 of the flow #4 so as to be in time for the passage of the packets.

However, the consumption amount of the tokens is dependent not only on the output rate of the packets, but also on the input rate. Therefore, in a case in which the input rate exceeds the agreed rate, only the output rate of the agreed rate is secured while using up the tokens. The packets in excess of the agreed bandwidth are discarded.

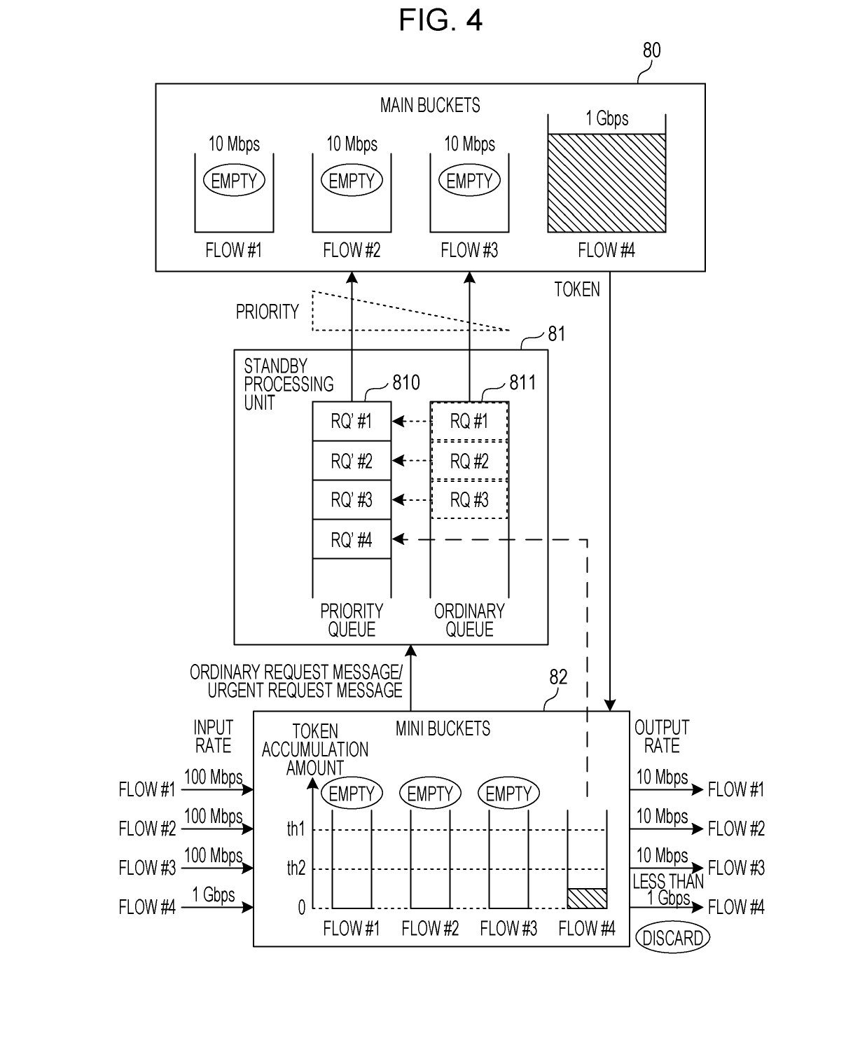

FIG. 4 illustrates an operational example of a policer of a comparative embodiment in an abnormal state. In FIG. 4, the same symbols are given to components which are shared with FIG. 3, and description thereof will be omitted.

In the present example, the input rate of the flows #1 to #3 is 100 Mbps, which exceeds the agreed rate of 10 Mpbs. The input rate of the flow #4 is 1 Gbps, which is the same as the agreed rate. In other words, of the flows #1 to #4, the flows #1 to #3 are bandwidth-exceeding flows which exceed the agreed bandwidth. Therefore, the main buckets 80 and the mini buckets 82 of the flows #1 to #3 are ordinarily depleted of tokens (refer to “empty”).

Therefore, the urgent request messages RQ′#1 to RQ′#3 of the flows #1 to #3 are ordinarily input to the priority queue 810. The urgent request message RQ′#4 of the flow #4 is also input to the priority queue 810 in the same manner; however, since the priority queue 810 is congested by the preceding urgent request messages RQ′#1 to RQ′#3, the urgent request message RQ′#4 is stored at the end. Therefore, the supply of tokens to the mini buckets 82 of the flow #4 is performed after that of the flows #1 to #3, the supply is not performed in time for the passage of the packets, and packet discarding arises (refer to “discarded”).

In this manner, in the comparative embodiment described above, since the urgent request messages RQ′#1 to RQ′#4 are output regardless of the input rate of each of the flows #1 to #4, the priority queue 810, which ordinarily would not become congested, becomes congested. As a result, the token supplying is not performed in time for the passage of the packets for the flow #4 which has an input rate of less than or equal to the agreed rate, and since packets are discarded, the output rate falls below the agreed rate of 1 Gbps. In other words, even though the input rate of the flow #4 is within the agreed rate, a problem arises in that the agreed bandwidth is not guaranteed.

Therefore, in the embodiments, the passage of the packets of each of the flows is controlled based on the tokens which are supplied according to the requests, and the performance of the bandwidth guarantee is improved by controlling the priority of requests for each flow according to the comparison results of the input rate of the packets and the agreed bandwidth for each flow.

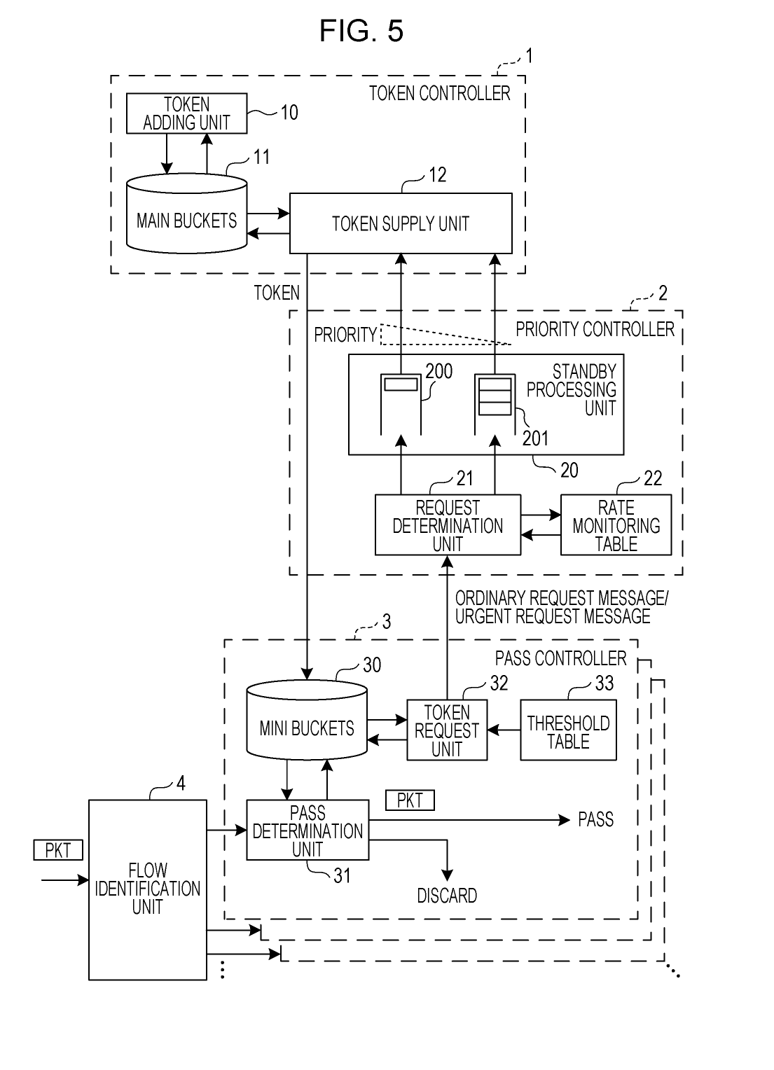

FIG. 5 is a configuration diagram illustrating an example of a policer of the embodiments. The policer is an example of a bandwidth control device and includes a token controller 1, a priority controller 2, a pass controller 3, and a flow identification unit 4.

The token controller 1 supplies the tokens to the pass controller 3 according to the requests. The token controller 1 includes a token adding unit 10, main buckets 11, and a token supply unit 12. The main buckets 11 are configured using memory, for example, and accumulate the tokens for each of the flows. The token adding unit 10 refers to the remaining amount of the tokens of the main buckets 11 and adds the token to the main buckets 11 using a predetermined algorithm.

When a request message is input from the priority controller 2, the token supply unit 12 detects the token accumulation amount in the main buckets 11 and outputs a fixed amount of the tokens to the pass controller 3. The token supply unit 12 subtracts a fixed amount from the token accumulation amount in the main buckets 11 after supplying the tokens.

The pass controller 3 requests tokens of the token controller 1 via the priority controller 2 for each of the flows of the packets (refer to “PKT”), and controls the passage of the packets for each of the flows based on the tokens which are supplied according to the request. The pass controller 3 includes mini buckets 30, a token request unit 32, a threshold table 33, and a pass determination unit 31.

The mini buckets 30 are configured using memory, for example, and the tokens which are supplied from the token controller 1 are accumulated in the mini buckets 30 for each of the flows. The pass determination unit 31 determines whether or not to pass the packets based on the token accumulation amount for each of the flows. More specifically, in a case in which the token accumulation amount is greater than 0, the pass determination unit 31 passes the packets, and in a case in which the token accumulation amount is less than or equal to 0, the pass determination unit 31 discards the packets. In other words, the pass determination unit 31 passes or discards the packets according to the token accumulation amount for each of the flows.

The pass determination unit 31 is not limited thereto, and may be configured to compare the token accumulation amount and the packet length, and, in a case in which token accumulation amount≧packet length, the pass determination unit 31 passes the packet, and in a case in which token accumulation amount<packet length, the pass determination unit 31 discards the packet. The pass determination unit 31 subtracts the packet length worth of tokens from the token accumulation amount in the mini buckets 30 each time a packet is passed.

The threshold table 33 is configured using memory, for example, and the first threshold th1 and the second threshold th2 which are the same as those of the comparative embodiment described above are written to the threshold table 33. The token request unit 32 refers to the token accumulation amount in the mini buckets 30 and compares the token accumulation amount with the first threshold th1 and the second threshold th2 which are read from the threshold table 33. In a case in which th2≦token accumulation amount<th1, the token request unit 32 outputs the ordinary request message to the priority controller 2, and in a case in which token accumulation amount<th2, the token request unit 32 outputs the urgent request message to the priority controller 2.

The flow identification unit 4 identifies the flow for each packet and outputs the packet to the pass determination unit 31 corresponding to the flow. The flow identification unit 4 identifies the flow based on the VID or the MPLS label of the packet, for example, or based on the input port (refer to FIG. 2).

The priority controller 2 compares the input rate of the packets with the agreed rate for each of the flows, and, for each of the flows, controls the priority of requests to the token controller 1 according to the comparison results. The priority controller 2 includes a standby processing unit 20, a request determination unit 21, and a rate monitoring table 22.

The rate monitoring table 22 is configured using memory, for example. The agreed rate for each of the flows is set in the rate monitoring table 22, and information relating to the input rate is written to the rate monitoring table 22. Here, the agreed rate is an example of a predetermined value for each of the flows. Detailed description of the content of the rate monitoring table 22 will be given later.

The request determination unit 21 refers to the rate monitoring table 22 and selects the ordinary request messages and the urgent request messages from a priority queue 200 and an ordinary queue 201 which are provided in the standby processing unit 20. More specifically, the request determination unit 21 outputs the ordinary request messages to the ordinary queue 201, and outputs the urgent request messages to the priority queue 200 in a case in which input rate≦agreed rate, and outputs the urgent request messages to the ordinary queue 201 in a case in which input rate>agreed rate.

The standby processing unit 20 outputs the request messages in the priority queue 200 to the token supply unit 12 with priority over the request messages in the ordinary queue 201. In other words, the priority of the priority queue 200 is higher than that of the ordinary queue 201.

In this manner, the priority controller 2 controls the priority of the token requests by allocating the ordinary request messages and the urgent request messages to the ordinary queue 201 or the priority queue 200. The priority controller 2 controls the priority of the token requests to the token controller 1 according to the comparison results of the input rate and the agreed rate for each of the flows.

Therefore, the priority controller 2 is capable of setting the priority of requests of the flow in which the input rate is less than or equal to the agreed rate to a value which is higher than the flow requests in which the input rate is greater than the agreed rate. Accordingly, since the tokens are preferentially supplied to the flows in which the input rate is less than or equal to the agreed rate, the agreed bandwidth of the flows is guaranteed.

The functions of the token controller 1 are not demanded to have the same level of processing speed as hardware. Therefore, the token controller 1 may be configured using software as a function of the processor 930 of the control card 93. In this case, it is possible to flexibly customize the algorithm of the token adding of the token adding unit 10 by changing the software.

Meanwhile, the functions of the pass controller 3 and the priority controller 2 are demanded to have high processing speeds according to the input rate of the packets. Therefore, the pass controller 3 and the priority controller 2 are provided with the input processing unit 912 and the storage unit 915 of the interface card 91 as hardware. Therefore, the sizes of the priority queue 200 and the ordinary queue 201 are determined according to the difference in processing speed between hardware and software, for example. The flow identification unit 4 is also provided in the input processing unit 912, and identifies the flow of packets which are input from the PHY and MAC unit 911.

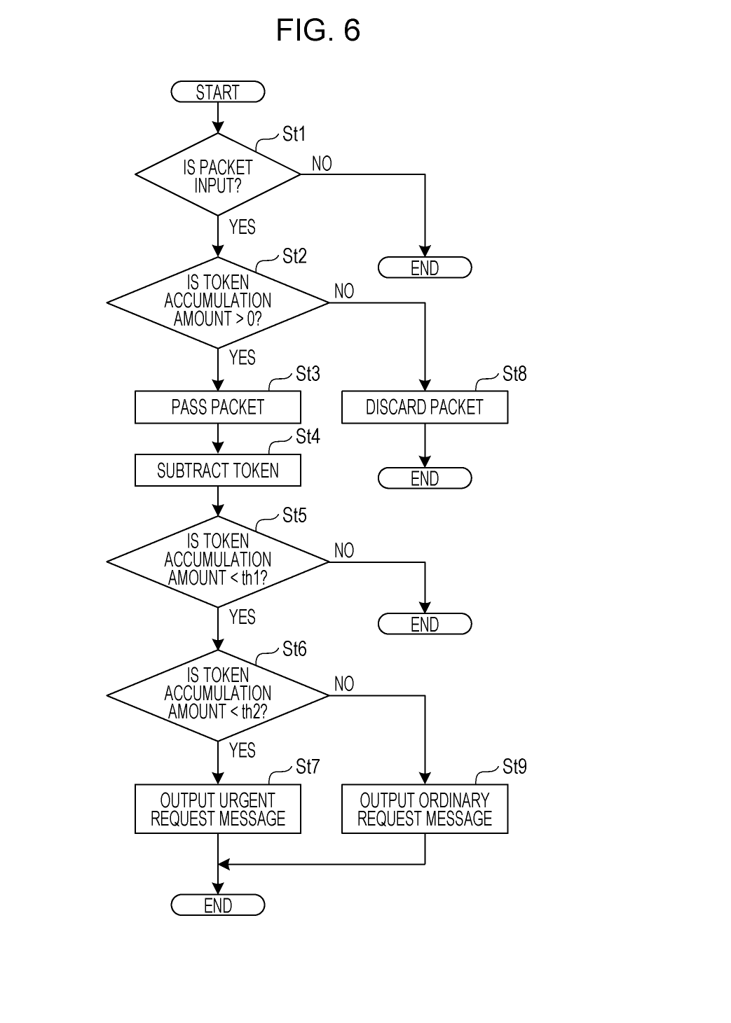

FIG. 6 is a flowchart illustrating an example of the operations of the pass controller 3. The present operations are executed periodically, for example.

The pass determination unit 31 determines whether or not a packet is input (operation St1). In a case in which a packet is not input (No in operation St1), the pass determination unit 31 ends the operation, and in a case in which a packet is input (Yes in operation St1), the pass determination unit 31 determines whether or not the token accumulation amount in the mini buckets 30 is greater than 0 (operation St2). The pass determination unit 31 may use a value other than 0 as the threshold of the token accumulation amount, and may alternatively compare the token accumulation amount to the packet length.

In a case in which token accumulation amount≦0 (No in operation St2), the pass determination unit 31 discards the packet (operation St8) and ends the operation. In a case in which token accumulation amount>0 (Yes in operation St2), the pass determination unit 31 passes the packet (operation St3). Next, the pass determination unit 31 subtracts the length the packet which is passed from the token accumulation amount in the mini buckets 30 (operation St4). The packet which is passed is passes through the later stage of the input processing unit 912 and is input to the switch card 92.

Next, the token request unit 32 compares the token accumulation amount with the first threshold th1 (operation St5). In a case in which token accumulation amount≧th1 (No in operation St5), the token request unit 32 ends the operation, and in a case in which token accumulation amount<th1 (Yes in operation St5), the token request unit 32 compares the token accumulation amount with the second threshold th2 (operation St6).

In a case in which token accumulation amount≧th2 (No in operation St6), the token request unit 32 outputs the ordinary request message to the request determination unit 21, and in a case in which token accumulation amount<th2 (Yes in operation St6), the token request unit 32 outputs the urgent request message to the request determination unit 21 (operation St7). The pass controller 3 operates in this manner.

In this manner, the pass controller 3 requests tokens when the tokens fall below the first threshold th1 and when the tokens fall below the second threshold th2. Therefore, it is possible to classify and output the token requests as the two levels of ordinary request messages and urgent request messages, and it is possible to supply tokens giving priority to the urgent request messages over the ordinary request messages.

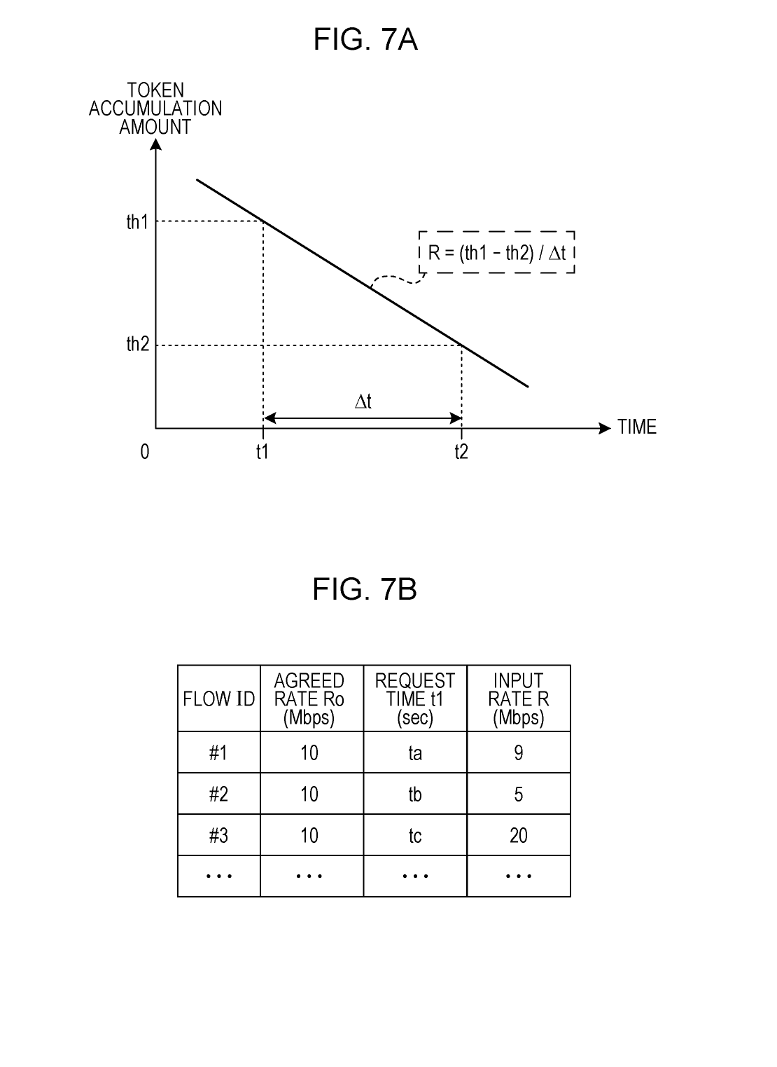

FIG. 7A is a graph illustrating an example of the change in token accumulation amount. In FIG. 7A, the horizontal axis depicts time and the vertical axis depicts the token accumulation amount.

The token accumulation amount falls below the first threshold th1 at time t1, and subsequently falls below the second threshold th2 at a time t2. The priority controller 2 calculates the input rate R Mbps from the difference between the first threshold th1 and the second threshold th2 and a time difference Δt (=t2−t1) between the time at which the token accumulation amount falls below the first threshold th1 and the time at which the token accumulation amount falls below the second threshold th2.

R=(th1−th2)/Δt (1)

The priority controller 2 calculates the input rate R using equation (1) denoted above. At this time, since the first threshold th1 and the second threshold th2 are fixed values, the priority controller 2 is capable of easily calculating the input rate R as an estimate value by tracking the time difference Δt between the times t1 and t2 at which the token accumulation amount falls below the first threshold th1 and the second threshold th2 using a counter or the like, for example.

FIG. 7B illustrates an example of the rate monitoring table 22. A flow ID, an agreed rate Ro Mbps, a request time t1 (sec), and an input rate R Mbps are recorded in the rate monitoring table 22 for each of the flows. The flow ID is an identifying number (#1, #2, #3, . . . ) which identifies the flow.

The agreed rate Ro is set in advance based on the agreed bandwidth of the user, and as long as the agreed content is not changed, the agreed rate is not changed. As described above, the request time t1 is the time at which the token accumulation amount falls below the first threshold th1. When the token accumulation amount falls below the first threshold th1, the request determination unit 21 detects the request time t1 and stores the request time t1 in the rate monitoring table 22. Subsequently, when the token accumulation amount falls below the second threshold th2, the request determination unit 21 detects the time t2, reads the request time t1 from the rate monitoring table 22, and calculates the input rate R from the equation (1) denoted above. The calculated input rate R is recorded in the rate monitoring table 22. Next, description will be given of the operations of the priority control based on the input rate R.

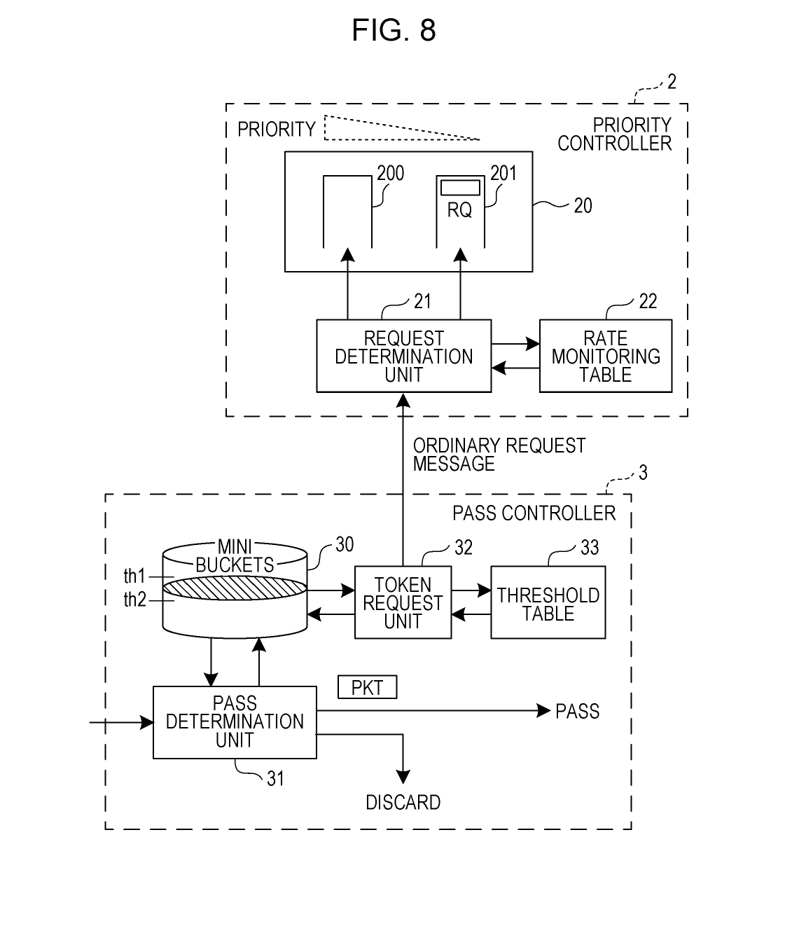

FIG. 8 illustrates an example of the operations of the policer when the token accumulation amount falls below the first threshold th1. In FIG. 8, the same symbols are given to components which are shared with FIG. 5, and description thereof will be omitted.

In the present example, the token accumulation amount in the mini buckets 30 falls below the first threshold th1 and is greater than or equal to the second threshold th2. In this case, the token request unit 32 outputs the ordinary request message to the request determination unit 21. Of the priority queue 200 and the ordinary queue 201, the request determination unit 21 inputs the ordinary request message to the ordinary queue 201, which has a low priority (refer to “RQ”).

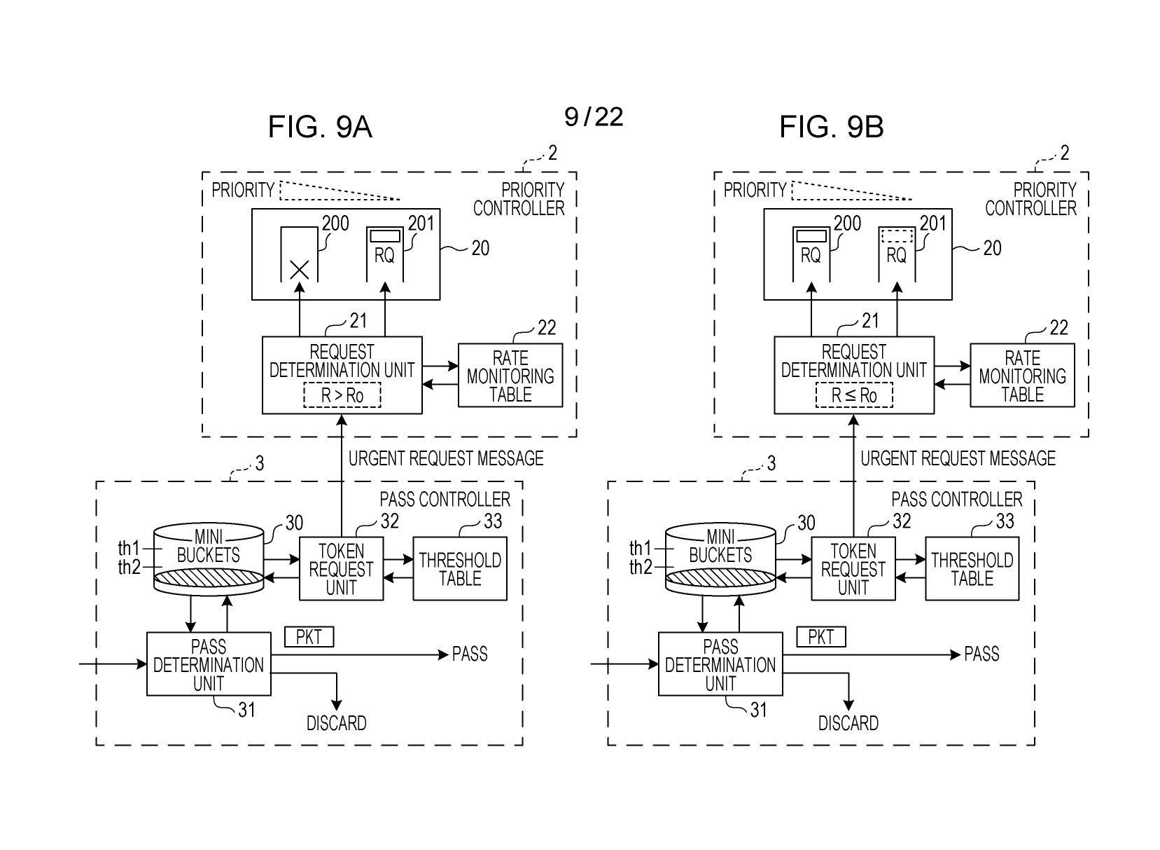

FIG. 9A illustrates an example of the operations of the policer when the token accumulation amount falls below the second threshold th2 in a case in which R>Ro. In FIG. 9A, the same symbols are given to components which are shared with FIG. 5, and description thereof will be omitted.

In the present example, the token accumulation amount in the mini buckets 30 falls below the second threshold th2. In this case, the token request unit 32 outputs the urgent request message to the request determination unit 21. However, since the input rate R of the corresponding flow exceeds the agreed rate Ro (refer to “R>Ro”), the request determination unit 21 does not input the ordinary queue to the priority queue 200 (refer to the X symbol) and leaves the request message stored in the ordinary queue 201.

Therefore, congestion of the priority queue 200 caused by urgent request messages of the flow in which the input rate R exceeds the agreed rate Ro is reduced.

FIG. 9B illustrates an example of the operations of the policer when the token accumulation amount falls below the second threshold th2 in a case in which R≦Ro. In FIG. 9B, the same symbols are given to components which are shared with FIG. 5, and description thereof will be omitted.

In the present example, the token accumulation amount in the mini buckets 30 falls below the second threshold th2. In this case, the token request unit 32 outputs the urgent request message to the request determination unit 21. Since the input rate R of the corresponding flow is less than or equal to the agreed rate Ro (refer to “R≦Ro”), the request determination unit 21 moves the request message from the ordinary queue 201 to the priority queue 200.

Therefore, tokens are supplied to the urgent request message of the flow in which the input rate R is less than or equal to the agreed rate Ro with priority over the flows in which the input rate R exceeds the agreed rate Ro. Therefore, the agreed bandwidth is guaranteed for the flows in which the input rate R is less than or equal to the agreed rate Ro.

In this manner, the priority controller 2 sets the priority of requests of the flow in which the input rate is less than or equal to the agreed rate to a value which is higher than the priority of requests of the flow in which the input rate exceeds the agreed rate. Therefore, tokens are supplied to the mini buckets 30 of the flows within the agreed bandwidth with priority over the bandwidth-exceeding flows.

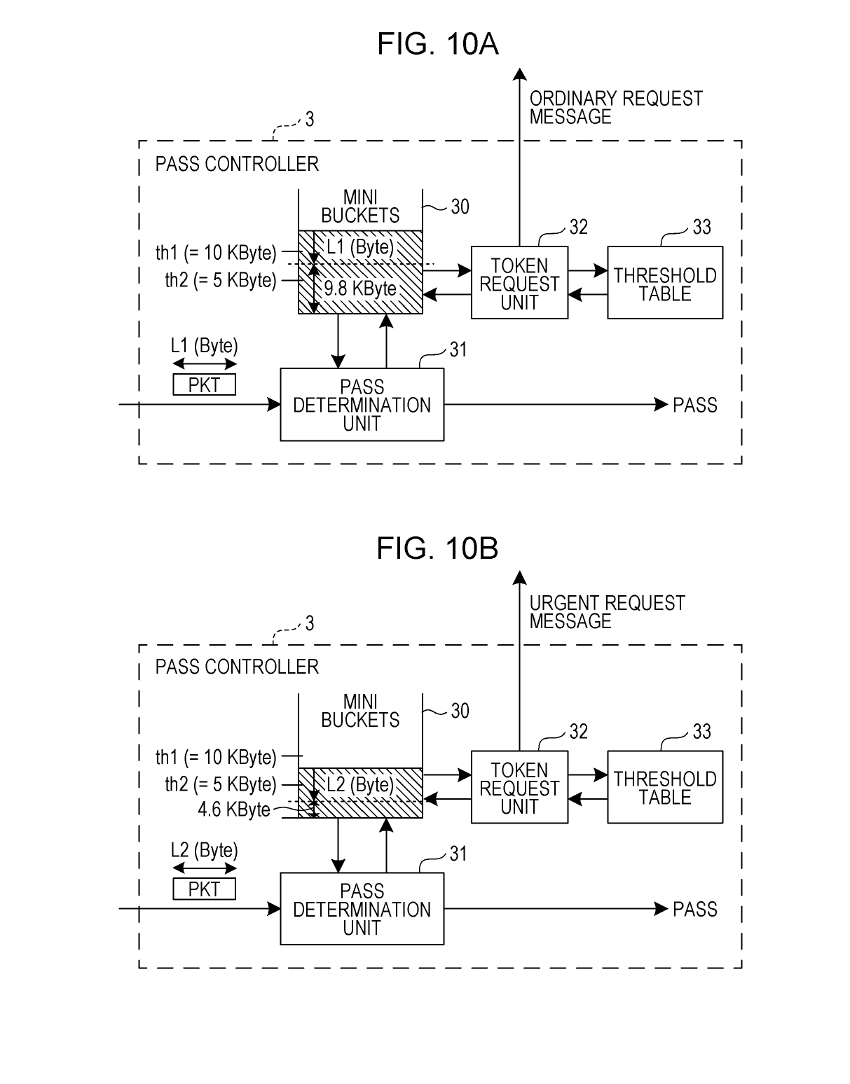

Next, description will be given of a calculation example of the input rate. FIG. 10A illustrates the output of an ordinary request message, and FIG. 10B illustrates the output of an urgent request message. In FIGS. 10A and 10B, the same symbols are given to components which are shared with FIG. 5, and description thereof will be omitted.

In the present example, the first threshold th1=10 KBytes and the second threshold th2=5 Kbytes. As illustrated in FIG. 10A, when the packet with a packet length L1 Bytes passes, the token accumulation amount is reduced by the packet length L1 Bytes. Accordingly, the token accumulation amount falls below the first threshold th1, and the ordinary request message is output from the token request unit 32.

As illustrated in FIG. 10B, after 10 msec elapses from the output of the ordinary request message, when the packet with a packet length L2 Bytes passes, the token accumulation amount is reduced by the packet length L2 Bytes. Accordingly, the token accumulation amount falls below the second threshold th2, and the urgent request message is output from the token request unit 32.

In the present example, since the time difference Δt between the output of the ordinary request message and the urgent request message is 10 msec, the input rate R is calculated from the equation (1) denoted above to be 4 Mbps (=(10 K−5 K)×8/0.01).

However, the token accumulation amount when the ordinary request message is output is not the same as the first threshold th1 depending on the packet length L1, and the token accumulation amount when the urgent request message is output is also not the same as the second threshold th2 depending on the packet length L2. Therefore, the input rate R which is calculated using equation (1) is an estimate value.

Therefore, the priority controller 2 may calculate the input rate R from the difference between the token accumulation amounts when the token accumulation amount falls below the first threshold th1 and the second threshold th2, respectively, and the time difference Δt between the time at which the token accumulation amount falls below the first threshold th1 and the time at which the token accumulation amount falls below the second threshold th2.

R=(A1−A2)/Δt (2)

The input rate R is calculated using equation (2) denoted above, for example. In equation (2), A1 is the token accumulation amount when the token accumulation amount falls below the first threshold th1, and A2 is the token accumulation amount when the token accumulation amount falls below the second threshold th2. Therefore, according to equation (2), the input rate R is calculated with higher precision than when using equation (1).

In the case of the present example, when token accumulation amount A1=9.8 KBytes (refer to FIG. 10A), and token accumulation amount A2=4.6 KBytes (refer to FIG. 10B), the input rate R is calculated as 4.16 Mbps (=(9.8 K−4.6 K)×8/0.01).

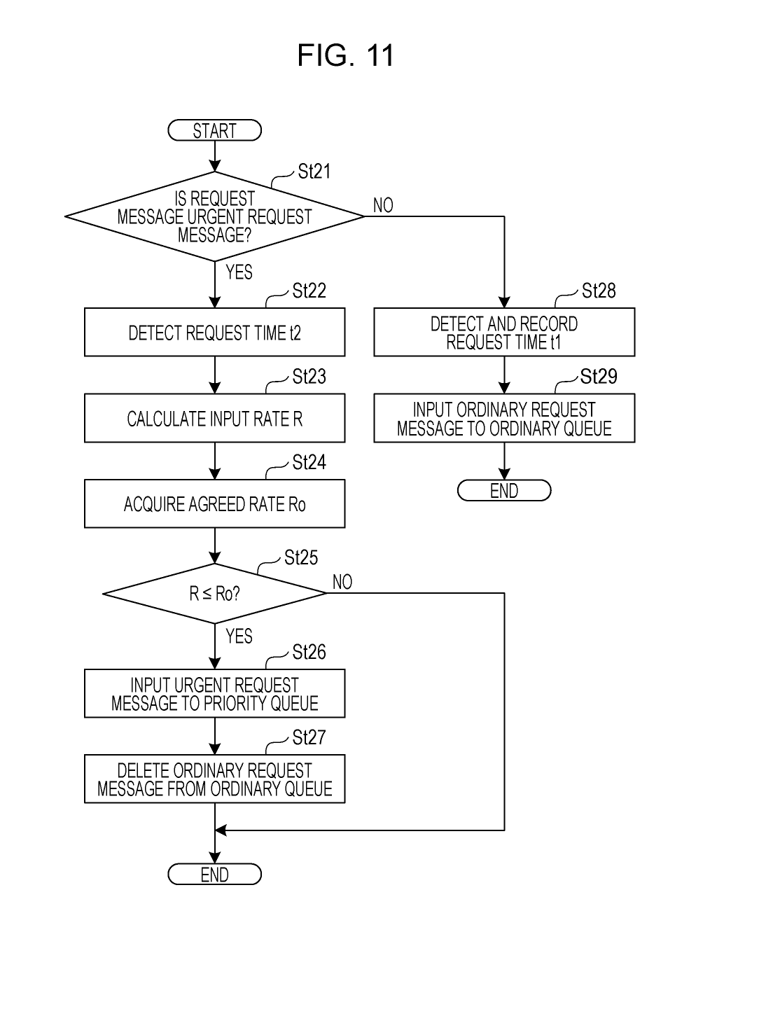

FIG. 11 is a flowchart illustrating an example of the operations of the request determination unit 21. In the present example, for example, the operations of the request determination unit 21 are performed using the input of a request message from the token request unit 32 as a trigger.

The request determination unit 21 determines whether or not the request message is an urgent request message (operation St21). In a case in which the request message is an ordinary request message (No in operation St21), the request determination unit 21 detects the request time t1 and records the request time t1 in the rate monitoring table 22 (operation St28). Next, the request determination unit 21 inputs the ordinary request message to the ordinary queue 201 (operation St29) and ends the operation.

In a case in which the request message is an urgent request message (Yes in operation St21), the request determination unit 21 detects the request time t2 (operation St22). The request times t1 and t2 are detected based on counter values, for example. Next, the request determination unit 21 calculates the input rate R using equation (1) denoted above (operation St23).

The request determination unit 21 may calculate the input rate R using equation (2) denoted above instead of equation (1) denoted above. In this case, the request determination unit 21 acquires the token accumulation amount A1 from the token request unit 32 in operation St28 described above, and records the token accumulation amount A1 and the request time t2 in the rate monitoring table 22. The request determination unit 21 acquires the token accumulation amount A2 from the token request unit 32 in operation St22 described above. The acquired token accumulation amounts A1 and A2 are used in the calculation of the input rate R.

Next, the request determination unit 21 acquires the agreed rate Ro corresponding to the flow from the rate monitoring table 22 (operation St24). Next, the request determination unit 21 compares the input rate R and the agreed rate Ro which are calculated (operation St25).

In a case in which R≦Ro as a result of the comparison (Yes in operation St25), the request determination unit 21 inputs the urgent request message to the priority queue 200 (operation St26). Next, the request determination unit 21 deletes the ordinary request message which is stored in the ordinary queue 201 (operation St27) and ends the operation. The request determination unit 21 may be configured to omit the process of operation St27 and leave the ordinary request message stored in the ordinary queue 201.

In a case in which R>Ro as a result of the comparison (No in operation St25), the request determination unit 21 ends the operation without storing the urgent request message in the priority queue 200. Accordingly, the priority of the token request of the flow which is within the agreed bandwidth (R≦Ro) is higher than that of the bandwidth-exceeding flows (R>Ro). The request determination unit 21 operates in this manner.

In the example described above, the request determination unit 21 controls the priority of requests based on the single calculated value of the input rate R; however, the configuration is not limited thereto. The request determination unit 21 may be configured to calculate an average value Rav of input rates R1 to R4 which are calculated over a plurality of times, compare the average value Rav with the agreed rate Ro, and control the priority of requests according to the comparison result. Accordingly, since erroneous determination of the priority caused by momentary fluctuations in the input rate R is reduced, it becomes possible to control the priority of requests with high precision.

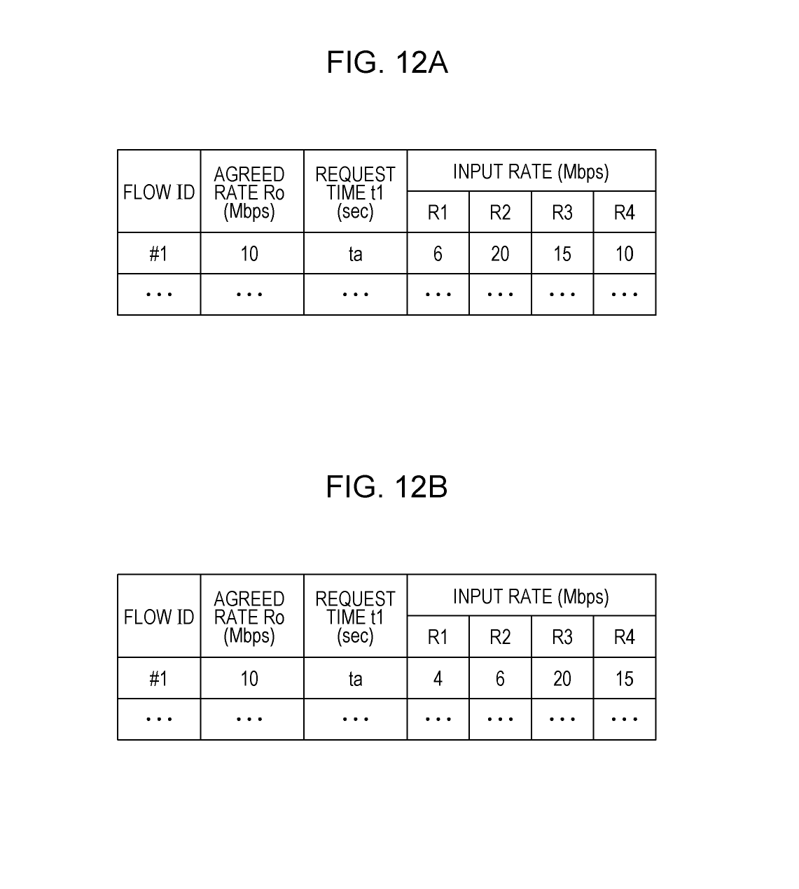

An example of the rate monitoring table 22 of this case is illustrated in FIGS. 12A and 12B. In FIGS. 12A and 12B, description of items which are shared with FIG. 7B will be omitted.

The plurality of input rates R1 to R4 which are calculated in different periods are recorded in the rate monitoring table 22. Of the input rates R1 to R4, the input rate R1 (=6 Mbps) is the newest value, and the input rate R4 is the oldest value. In the present example, the input rates R1 to R4 of the four periods are recorded in the rate monitoring table 22; however, the number of the input rates R1 to R4 to record is not limited.

Rav=(R+R1+R2+R3+R4)/5 equation (3)

The request determination unit 21 calculates the moving average value Rav of the input rates R1 to R4 and the input rate R which is newly calculated using equation (3) denoted above. In the case of the example of FIG. 12A, when the newly calculated input rate R=4 Mbps, the input rates R1 to R4 are 6 Mbps, 20 Mbps, 15 Mbps, and 10 Mbps, respectively, and thus, the moving average value Rav is calculated as 11 Mbps (=(4+6+20+15+10)/5).

In a case in which the newly calculated input rate R=4 Mbps and agreed rate Ro=10 Mbps are compared, the request determination unit 21 determines that R<Ro (within agreed bandwidth); however, in a case in which moving average value Rav=11 Mbps and agreed rate Ro=10 Mbps are compared, the request determination unit 21 determines that R≧Ro (bandwidth is exceeded). In this manner, the request determination unit 21 becomes capable of more accurate determination through a smoothened input rate by using the moving average value Rav in the priority determination. The moving average value Rav is an example of an average value, and a weighted moving average value or the like may be used instead, for example.

The plurality of input rates R1 to R4 are updated every time the input rate R is newly calculated. FIG. 12A illustrates the rate monitoring table 22 prior to updating, and FIG. 12B illustrates an example of the rate monitoring table 22 after updating. When the input rate R is newly calculated, the newly calculated input rate R (=4 Mbps) is newly recorded as the input rate R1. The input rates R1 to R3 prior to updating are newly recorded as the input rates R2 to R4. Accordingly, the input rate R4 prior to updating is erased from the rate monitoring table 22.

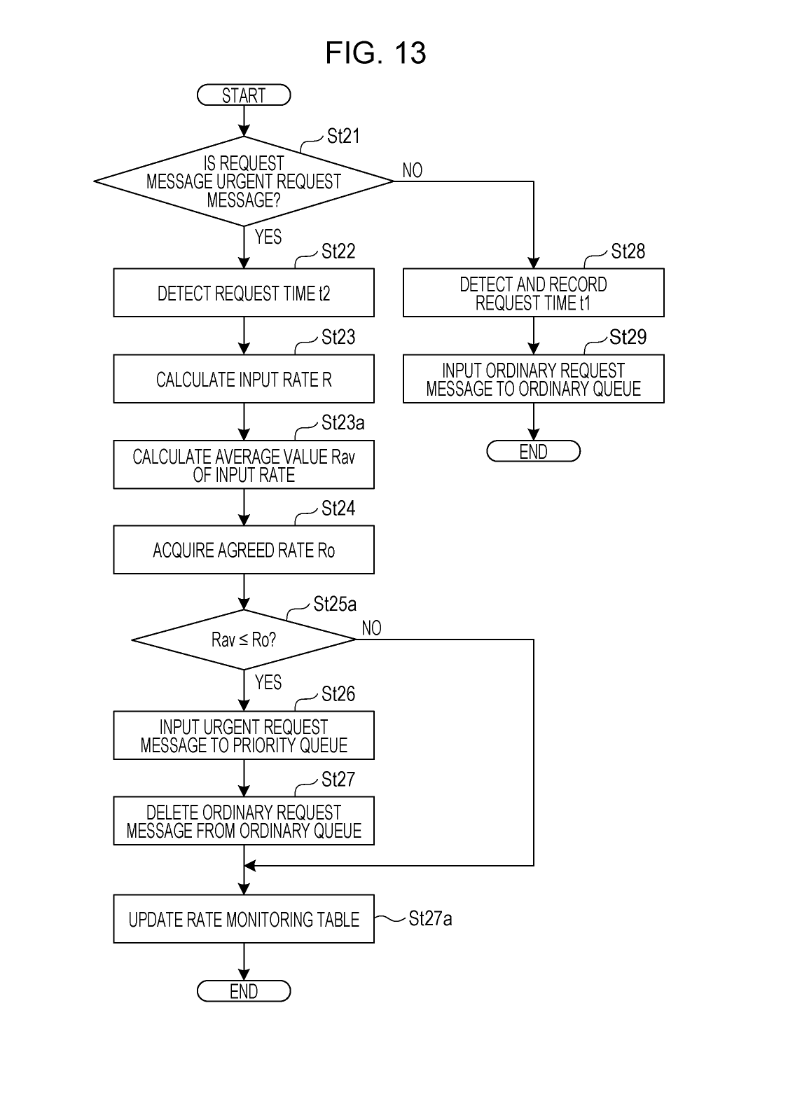

FIG. 13 is a flowchart illustrating the operations of the request determination unit 21 of the present example. In FIG. 13, the same symbols are given to processes which are shared with FIG. 11, and description thereof will be omitted.

After calculating the input rate R (operation St23), the request determination unit 21 calculates the moving average value Rav using equation (3) denoted above from the input rate R and the four input rates R1 to R4 which are recorded in the rate monitoring table 22 (operation St23a). Next, the request determination unit 21 acquires the agreed rate Ro from the rate monitoring table 22 (operation St24), and compares the agreed rate Ro with the calculated moving average value Rav (operation St25a).

In a case in which Rav≦Ro (Yes in operation St25a), the request determination unit 21 performs the same processes as in FIG. 11 (operations St26 and St27), and the updating process of the rate monitoring table 22 described with reference to FIGS. 12A and 12B is performed (operation St27a). In a case in which Rav>Ro (No in operation St25a), the request determination unit 21 performs the updating process of the rate monitoring table 22 (operation St27a) without performing the processes of operations St26 and St27. The request determination unit 21 operates in this manner.

The priority controller 2 may be configured to detect whether or not packets are discarded for each of the flows for each period from the request until the supply of tokens in the pass controller 3, compare the determined number of discarded packets in the plurality of periods with a predetermined number for each of the flows, and control the priority of requests for tokens to the token controller 1 according to the comparison results for each of the flows. As described above, in the case of a bandwidth-exceeding flow, since the packets which exceed the agreed rate Ro are discarded, it is possible to distinguish the bandwidth-exceeding flow based on the number of periods in which packets are discarded. Therefore, it becomes possible to control the priority of requests using a low load process without performing a calculation process of the input rate R.

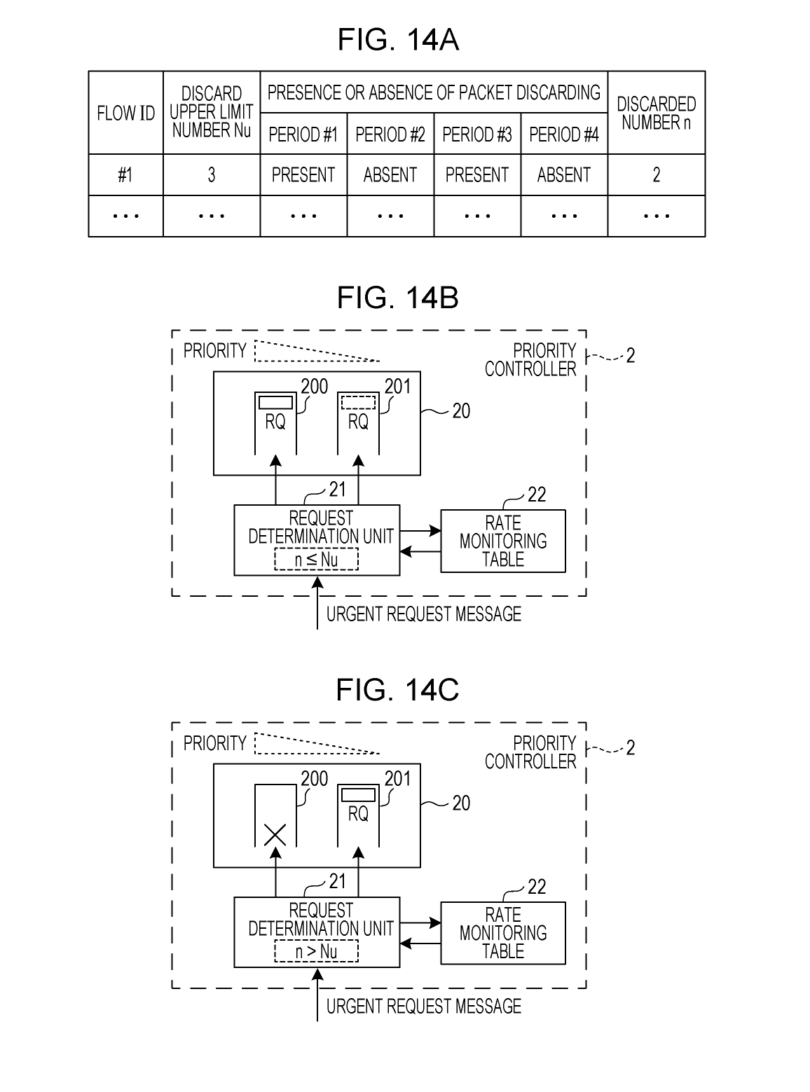

FIG. 14A illustrates the rate monitoring table 22 in the case of the embodiments described above. The flow ID, a discard upper limit number Nu, whether or not packets (PKT) are discarded for each of the periods #1 to #4, and a discarded number n are recorded in the rate monitoring table 22. The discard upper limit number Nu is set for each of the flows according to the agreed rate thereof.

Each of the periods #1 to #4 is a period from a request until the supply of tokens in the pass controller 3. For example, the periods #1 to #4 are periods from when the pass controller 3 outputs an urgent request message until the tokens are supplied, and are managed using a counter in the priority controller 2, for example. In the present example, the four periods #1 to #4 are exemplified; however, there is no limit to the number of periods which are recorded in the rate monitoring table 22.

The priority controller 2 detects whether or not there is discarding in the periods #1 to #4 from the notification of the pass determination unit 31, and the number of the periods #1 to #4 in which discarding is “present” is recorded in the discarded number n. Of the periods #1 to #4, the period #1 is the newest, the period #4 is the oldest, and “presence or absence of PKT discarding” of the periods #1 to #4 is updated every time the presence or absence of discarding is newly detected. In other words, the new detection results of presence or absence of discarding are newly recorded as the “presence or absence of PKT discarding” of the period #1. The “presence or absence of PKT discarding” of the periods #1 to 3 prior to updating are newly recorded as the “presence or absence of PKT discarding” of the periods #2 to #4. Accordingly, the “presence or absence of PKT discarding” of the period #4 prior to updating are erased from the rate monitoring table 22.

FIG. 14B illustrates an example of the operations of the policer when the token accumulation amount falls below the second threshold th2 in a case in which n≦Nu (refer to inside the dotted line box). In FIG. 14B, the same symbols are given to components which are shared with FIG. 5, and description thereof will be omitted.

In a case in which n≦Nu, the request determination unit 21 moves the request message RQ from the ordinary queue 201 to the priority queue 200. More specifically, the request determination unit 21 inputs the urgent request message to the priority queue 200 (refer to solid line RQ), and deletes the ordinary request message which is already stored in the ordinary queue 201 (refer to dotted line RQ). Accordingly, the request of the flow in which n≦Nu, that is, the flow within the agreed rate is preferentially output to the token controller 1.

Meanwhile, FIG. 14C illustrates an example of the operations of the policer when the token accumulation amount falls below the second threshold th2 in a case in which n>Nu (refer to inside the dotted line box). In FIG. 14C, the same symbols are given to components which are shared with FIG. 5, and description thereof will be omitted.

The request determination unit 21 does not input the ordinary queue to the priority queue 200 (refer to the X symbol) and leaves the request message stored in the ordinary queue 201. In other words, the request determination unit 21 discards the urgent request message and does not perform prioritized processing. Accordingly, the request of the flow in which n>Nu, that is, the bandwidth-exceeding flow may be reduced from being preferentially output to the token controller 1.

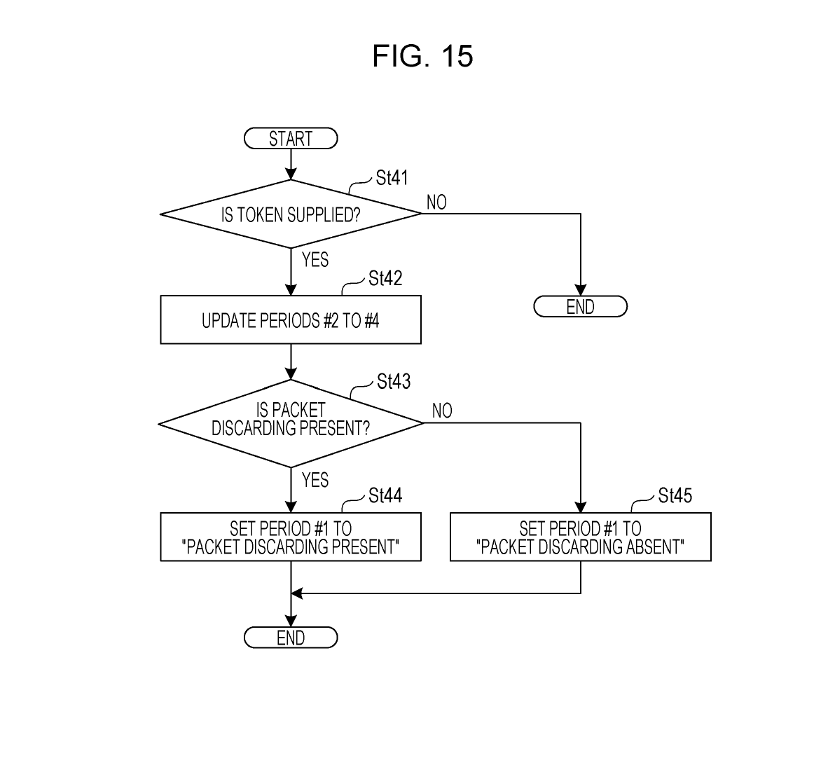

FIG. 15 is a flowchart illustrating an example of the updating process of the rate monitoring table 22. The present process is performed in a fixed period, for example.

The request determination unit 21 determines whether or not a token is supplied (operation St41). For example, when the request message is output from the ordinary queue 201 or the priority queue 200, the request determination unit 21 determines that a token is supplied.

In a case in which there is no supply of tokens (No in operation St41), the request determination unit 21 ends the process, and in a case in which there is a supply of tokens (Yes in operation St41), the request determination unit 21 updates the “presence or absence of PKT discarding” of the periods #2 to #4 of the rate monitoring table 22 (operation St42). More specifically, the request determination unit 21 newly records the “presence or absence of PKT discarding” of the periods #1 to 3 prior to updating as the “presence or absence of PKT discarding” of the periods #2 to #4, respectively.

Next, the request determination unit 21 detects whether or not packets are discarded in the newest period based on the notification from the pass determination unit 31 (operation St43). In a case in which discarding is present (Yes in operation St43), the request determination unit 21 sets the “presence or absence of PKT discarding” of the period #1 to “present” (operation St44), and in a case in which discarding is not present (No in operation St43), the request determination unit 21 sets the “presence or absence of PKT discarding” of the period #1 to “absent” (operation St45) and ends the process. In this manner, the updating process of the rate monitoring table 22 is performed.

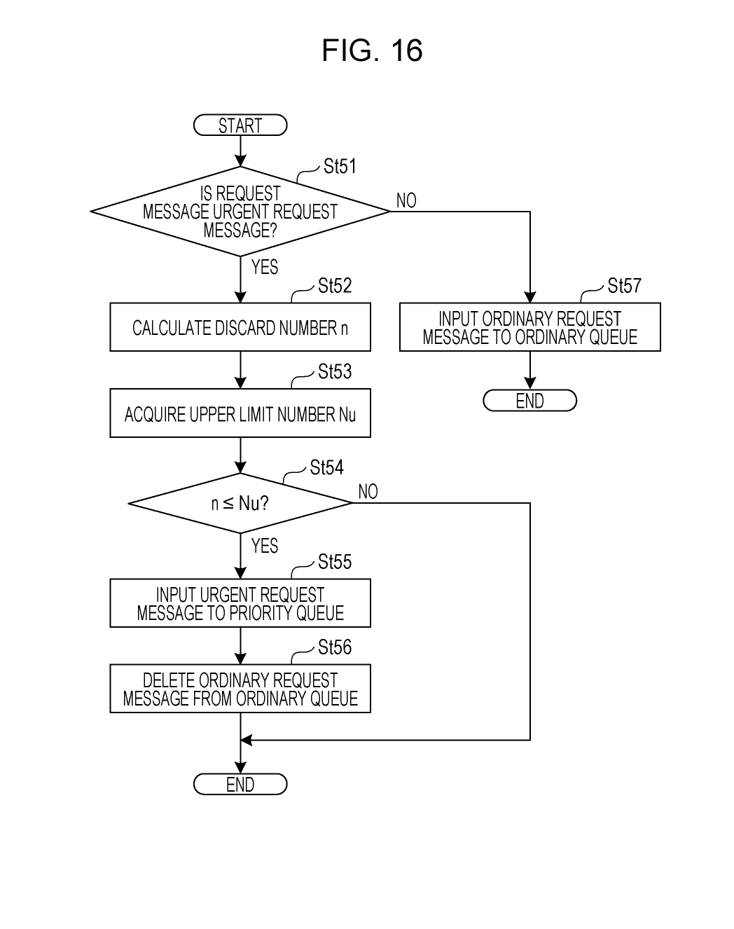

FIG. 16 is a flowchart illustrating the operations of the request determination unit 21 of the present example. In the present example, for example, the operations of the request determination unit 21 are performed using the input of a request message from the token request unit 32 as a trigger.

The request determination unit 21 determines whether or not the request message is an urgent request message (operation St51). In a case in which the request message is an ordinary request message (No in operation St51), the request determination unit 21 inputs the ordinary request message to the ordinary queue 201 (operation St57) and ends the operation.

In a case in which the request message is an urgent request message (Yes in operation St51), the request determination unit 21 calculates the discarded number n of the packets from the “presence or absence of PKT discarding” of the periods #1 to #4 of the rate monitoring table 22 (operation St52). The calculated discarded number n of packets is recorded in the rate monitoring table 22. Next, the request determination unit 21 acquires the upper limit number Nu from the rate monitoring table 22 (operation St53).

Next, the request determination unit 21 compares the discarded number n and the discard upper limit number Nu of packets (operation St54). In a case in which n≦Nu (Yes in operation St54), the request determination unit 21 inputs the urgent request message to the priority queue 200 (operation St55). Next, the request determination unit 21 deletes the ordinary request message of the same flow as the urgent request message from the ordinary queue 201 (operation St56) and ends the operation. The process of operation St56 may be omitted.

In a case in which n<Nu (No in operation St54), the request determination unit 21 ends the operation without storing the urgent request message in the priority queue 200. Accordingly, the priority of the token request of the flow which is within the agreed bandwidth (R≦Ro) is higher than that of the bandwidth-exceeding flows (R>Ro). The request determination unit 21 operates in this manner.

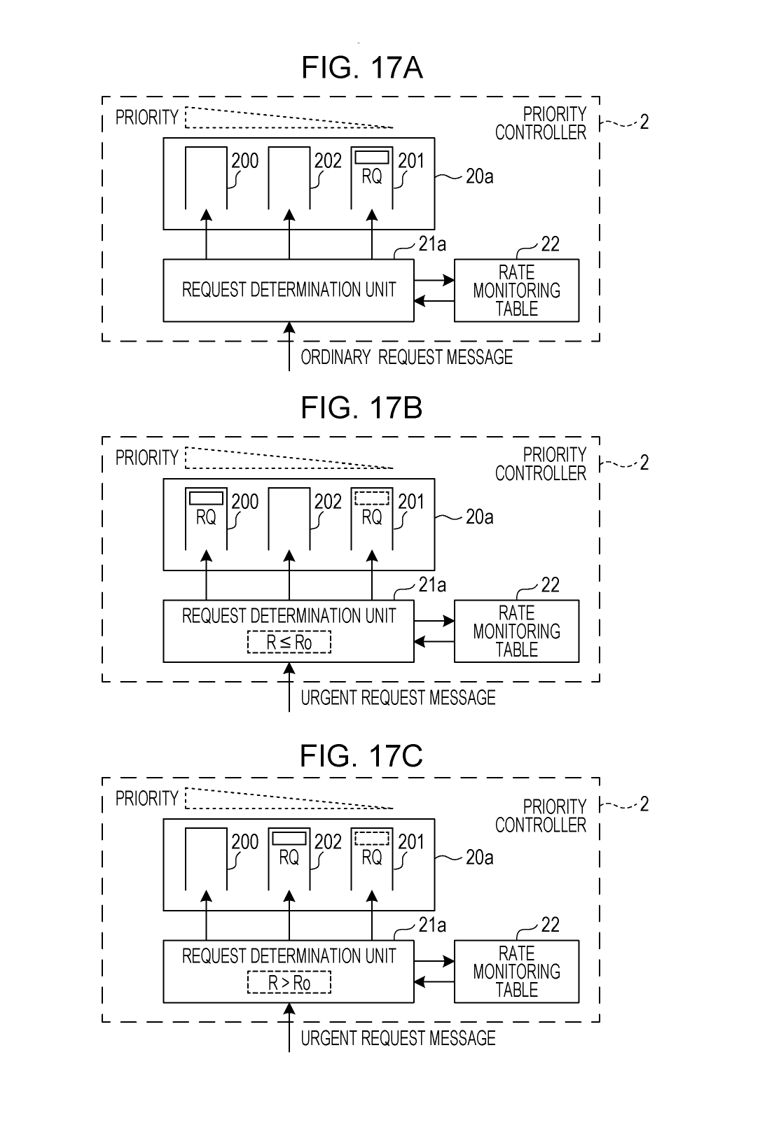

In the embodiments described hereunto, only the two queues 200 and 201 are provided in the standby processing unit 20; however, the configuration is not limited thereto. For example, as illustrated in FIGS. 17A to 17C, in addition to the ordinary queue 201 and the priority queue 200, a standby processing unit 20a may be provided with a following priority queue 202 into which urgent request messages of a bandwidth-exceeding flow are input.

More specifically, FIG. 17A illustrates the operations of the priority controller 2 of a case in which an ordinary request message is input. In FIG. 17A, the same symbols are given to components which are shared with FIG. 5, and description thereof will be omitted.

The standby processing unit 20a is provided with the ordinary queue 201, the priority queue 200, and the following priority queue 202. Of the ordinary queue 201, the priority queue 200, and the following priority queue 202, the priority of the priority queue 200 is highest, the priority of the following priority queue 202 is next highest, and the priority of the ordinary queue 201 is lowest. The standby processing unit 20a outputs the request messages to the token controller 1 in an order according to these priorities.

In a case in which the ordinary request message is input, a request determination unit 21a inputs the ordinary request message to the ordinary queue 201 regardless of the input rate R (refer to RQ).

FIG. 17B illustrates the operations of the priority controller 2 of a case in which an urgent request message of a flow in which R≦Ro is input. In FIG. 17B, the same symbols are given to components which are shared with FIG. 5, and description thereof will be omitted.

When the urgent request message is input, if the request determination unit 21a determines from the rate monitoring table 22 that the input rate R of the flow is less than or equal to the agreed rate Ro (refer to “R≦Ro”), the request determination unit 21a moves the request message from the ordinary queue 201 to the priority queue 200. More specifically, the request determination unit 21a inputs the urgent request message to the priority queue 200 (refer to solid line RQ), and deletes the ordinary request message which is already stored in the ordinary queue 201 (refer to dotted line RQ).

FIG. 17C illustrates the operations of the priority controller 2 of a case in which an urgent request message of a flow in which R>Ro is input. In FIG. 17C, the same symbols are given to components which are shared with FIG. 5, and description thereof will be omitted.

When the urgent request message is input, if the request determination unit 21a determines from the rate monitoring table 22 that the input rate R of the flow is greater than the agreed rate Ro (refer to “R>Ro”), the request determination unit 21a moves the request message from the ordinary queue 201 to the following priority queue 202. More specifically, the request determination unit 21a inputs the urgent request message to the following priority queue 202 (refer to solid line RQ), and deletes the ordinary request message which is already stored in the ordinary queue 201 (refer to dotted line RQ).

In this manner, the priority controller 2 inputs the urgent request message into the priority queue 200 or the following priority queue 202, and thus, the priority controller 2 sets the priority of requests of the flow in which the token accumulation amount falls below the second threshold th2 to a higher value than the priority of requests of the flow in which the token accumulation amount falls below the first threshold th1. Therefore, the tokens are supplied to the mini buckets 30 which appear to be almost depleted of tokens with priority over the mini buckets 30 in which sufficient tokens are accumulated.

The priority controller 2 inputs the urgent request message of the flow which is within the agreed rate Ro to the priority queue 200 and inputs the urgent request message of the bandwidth-exceeding flow to the following priority queue 202. Accordingly, of the flows in which the token accumulation amount falls below the second threshold th2, the priority controller 2 sets the priority of requests of the flow in which the input rate R is less than or equal to the agreed rate R to a value which is higher than the priority of requests of the flow in which the input rate R exceeds the agreed rate Ro. Therefore, even in the mini buckets 30 of a bandwidth-exceeding flow, in a case in which the urgent request message is output, tokens are supplied with priority over those for which ordinary request messages are output.

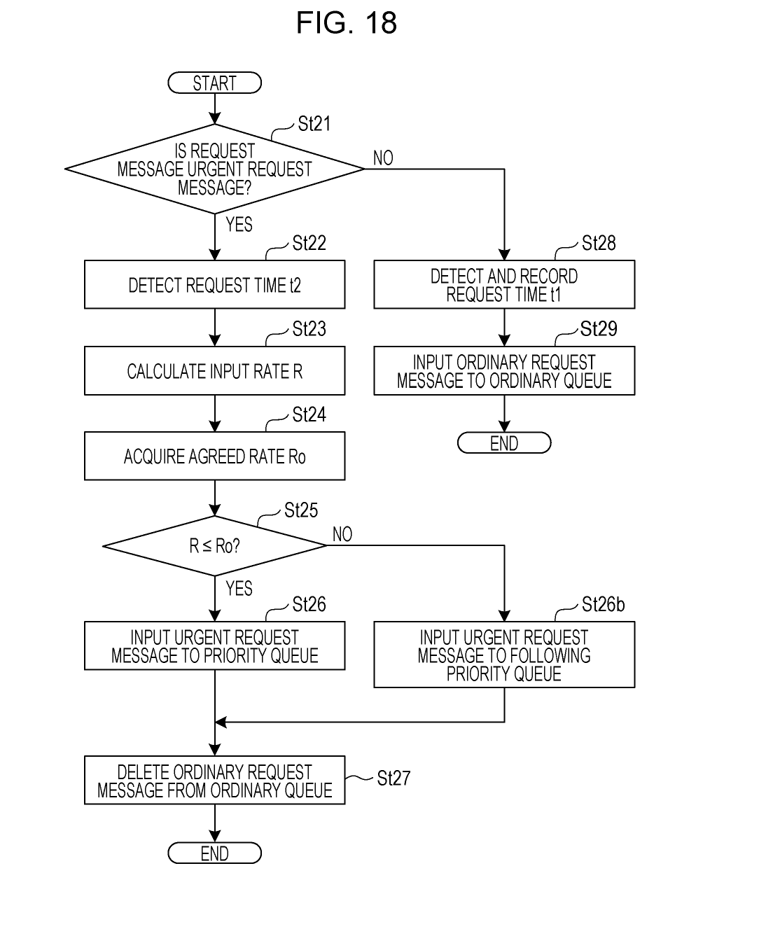

FIG. 18 is a flowchart illustrating the operations of the request determination unit 21a of the present example. In FIG. 18, the same symbols are given to processes which are shared with FIG. 11, and description thereof will be omitted.

In a case in which the input rate R and the agreed rate Ro are compared (operation St25) and R≦Ro (Yes in operation St25), the request determination unit 21a inputs the urgent request message to the priority queue 200 (operation St26). In a case in which R>Ro (No in operation St25), the request determination unit 21a inputs the urgent request message to the following priority queue 202 (operation St26b). Therefore, the urgent request message is output to the token controller 1 with priority over the ordinary request message regardless of the comparison results of the input rate R and the agreed rate Ro.

Next, the request determination unit 21a deletes the ordinary request message of the same flow as the urgent request message from the ordinary queue 201 (operation St27) and ends the operation. The process of operation St27 may be omitted. The request determination unit 21a operates in this manner.

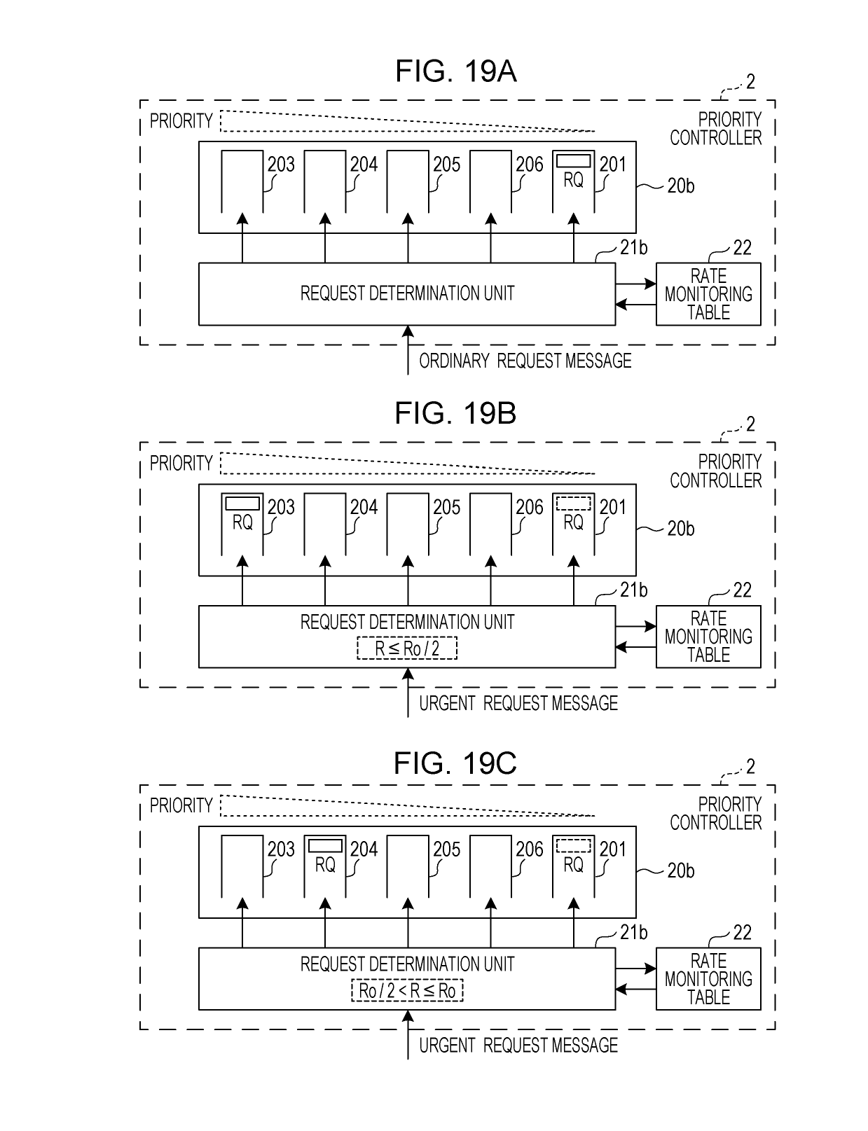

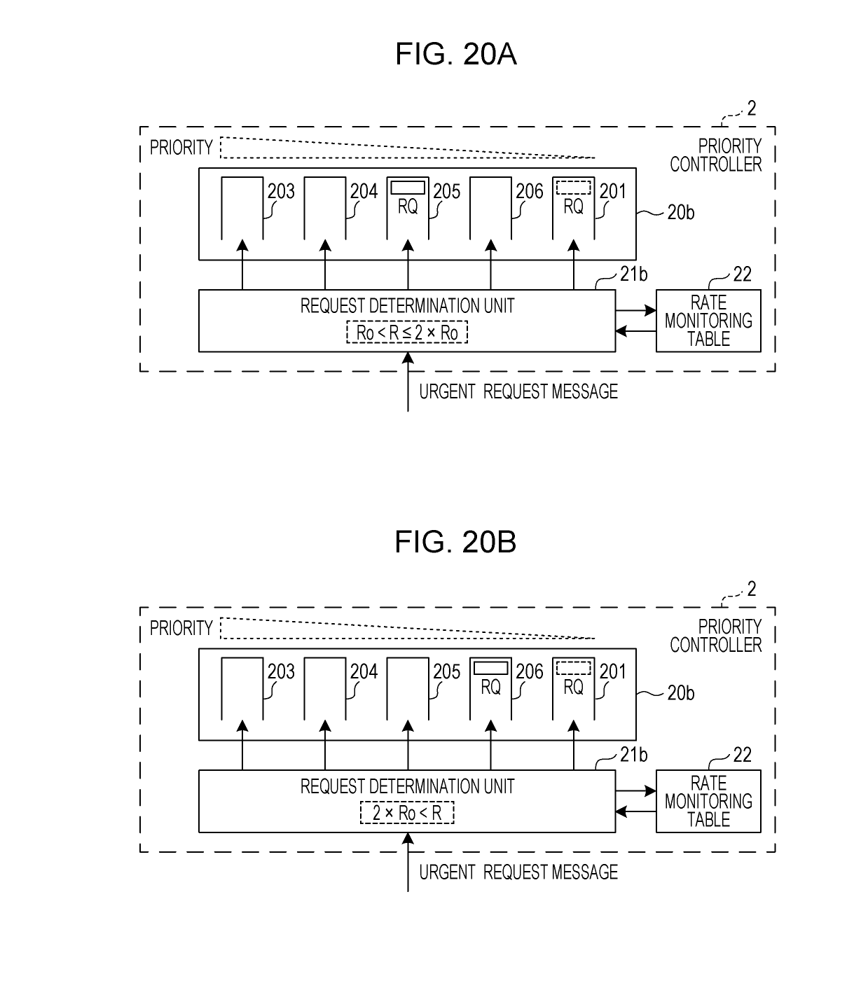

The priority controller 2 may divide the priority of requests into a plurality of levels corresponding to the differences between the input rate R and the agreed rate Ro. For example, as illustrated in FIGS. 19A to 19C, 20A, and 20B, in addition to the ordinary queue 201, a standby processing unit 20b may be provided with first to fourth queues 203 to 206 corresponding to the differences between the input rate R and the agreed rate Ro.

FIG. 19A illustrates the operations of the priority controller 2 of a case in which an ordinary request message is input. In FIG. 19A, the same symbols are given to components which are shared with FIG. 5, and description thereof will be omitted.

The standby processing unit 20b may be provided with the ordinary queue 201 and the first to fourth queues 203 to 206. The ordinary request messages are input to the ordinary queue 201, and the urgent request messages are input to the first to fourth queues 203 to 206. The first to fourth queues 203 to 206 are used differently according to the differences between the input rate R and the agreed rate Ro.

As described hereinafter, in a case in which R≦Ro/2, the urgent request message is input to the first queue 203, and in a case in which Ro/2<R≦Ro, the urgent request message is input to the second queue 204. In a case in which Ro<R≦2×Ro, the urgent request message is input to the third queue 205, and in a case in which 2×Ro<R, the urgent request message is input to the fourth queue 206.

The priorities of the first to fourth queues 203 to 206 descend in order of the first queue 203 which has the highest priority, the second queue 204, the third queue 205, and the fourth queue 206. The priority of the ordinary queue 201 is lower than that of the fourth queue 206. The standby processing unit 20b outputs the request messages to the token controller 1 in an order according to these priorities.

In a case in which the ordinary request message is input, a request determination unit 21b inputs the ordinary request message to the ordinary queue 201 regardless of the input rate R (refer to RQ).

FIG. 19B illustrates the operations of the priority controller 2 of a case in which an urgent request message of a flow in which R≦Ro/2 is input. In FIG. 19B, the same symbols are given to components which are shared with FIG. 5, and description thereof will be omitted.

When the urgent request message is input, if the request determination unit 21b determines from the rate monitoring table 22 that the input rate R of the flow is less than or equal to ½ of the agreed rate Ro (refer to “R≦Ro/2”), the request determination unit 21b moves the request message from the ordinary queue 201 to the first queue 203. More specifically, the request determination unit 21b inputs the urgent request message to the first queue 203 (refer to solid line RQ), and deletes the ordinary request message which is already stored in the ordinary queue 201 (refer to dotted line RQ).

FIG. 19C illustrates the operations of the priority controller 2 of a case in which an urgent request message of a flow in which Ro/2<R≦Ro is input. In FIG. 19C, the same symbols are given to components which are shared with FIG. 5, and description thereof will be omitted.

When the urgent request message is input, if the request determination unit 21b determines from the rate monitoring table 22 that the input rate R of the flow is greater than ½ of the agreed rate Ro and less than or equal to the agreed rate Ro (refer to “Ro/2<R≦Ro”), the request determination unit 21b moves the request message from the ordinary queue 201 to the second queue 204. More specifically, the request determination unit 21b inputs the urgent request message to the second queue 204 (refer to solid line RQ), and deletes the ordinary request message which is already stored in the ordinary queue 201 (refer to dotted line RQ).

FIG. 20A illustrates the operations of the priority controller 2 of a case in which an urgent request message of a flow in which Ro<R≦2×Ro is input. In FIG. 20A, the same symbols are given to components which are shared with FIG. 5, and description thereof will be omitted.

When the urgent request message is input, if the request determination unit 21b determines from the rate monitoring table 22 that the input rate R of the flow is greater than the agreed rate Ro and less than or equal to double the agreed rate Ro (refer to “Ro<R≦2×Ro”), the request determination unit 21b moves the request message from the ordinary queue 201 to the third queue 205. More specifically, the request determination unit 21b inputs the urgent request message to the third queue 205 (refer to solid line RQ), and deletes the ordinary request message which is already stored in the ordinary queue 201 (refer to dotted line RQ).

FIG. 20B illustrates the operations of the priority controller 2 of a case in which an urgent request message of a flow in which 2×Ro<R is input. In FIG. 20B, the same symbols are given to components which are shared with FIG. 5, and description thereof will be omitted.

When the urgent request message is input, if the request determination unit 21b determines from the rate monitoring table 22 that the input rate R of the flow is less than or equal to double the agreed rate Ro (refer to “2×Ro<R”), the request determination unit 21b moves the request message from the ordinary queue 201 to the fourth queue 206. More specifically, the request determination unit 21b inputs the urgent request message to the fourth queue 206 (refer to solid line RQ), and deletes the ordinary request message which is already stored in the ordinary queue 201 (refer to dotted line RQ).

In this manner, since the request determination unit 21b controls the priority of the urgent request messages in four levels corresponding to the differences between the input rate R and the agreed rate Ro, high precision priority control becomes possible.

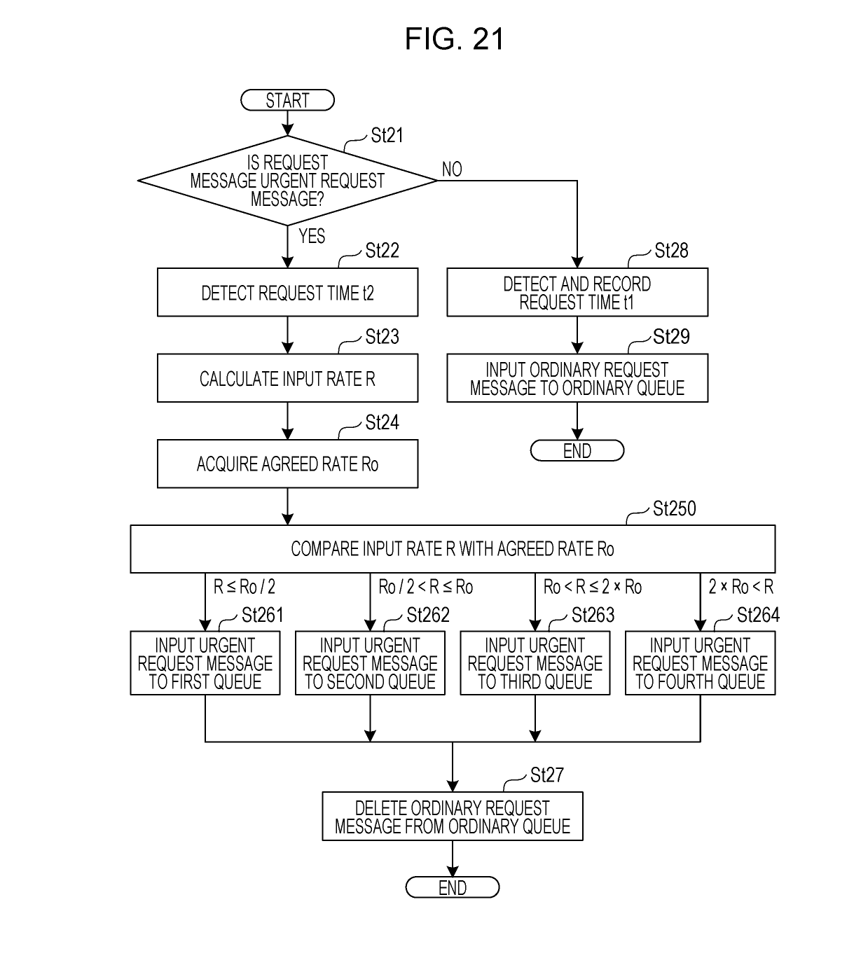

FIG. 21 is a flowchart illustrating the operations of the request determination unit 21b of the present example. In FIG. 21, the same symbols are given to processes which are shared with FIG. 11, and description thereof will be omitted.

After acquiring the agreed rate Ro (operation St24), the request determination unit 21b compares the input rate R and the agreed rate Ro which are calculated (operation St250). In a case in which R≦Ro/2, the request determination unit 21b inputs the urgent request message to the first queue 203 (operation St261), and in a case in which Ro/2<R≦Ro, the request determination unit 21b inputs the urgent request message to the second queue 204 (operation St262).

In a case in which Ro<R≦2×Ro, the request determination unit 21b inputs the urgent request message to the third queue 205 (operation St263), and in a case in which 2×Ro<R, the request determination unit 21b inputs the urgent request message to the fourth queue 206 (operation St264). Therefore, the request determination unit 21b is capable of controlling the priority of the urgent request messages divided into four levels corresponding to the differences between the input rate R and the agreed rate Ro.

Next, the request determination unit 21b deletes the ordinary request message of the same flow as the urgent request message from the ordinary queue 201 (operation St27) and ends the operation. The process of operation St27 may be omitted. The request determination unit 21b operates in this manner.

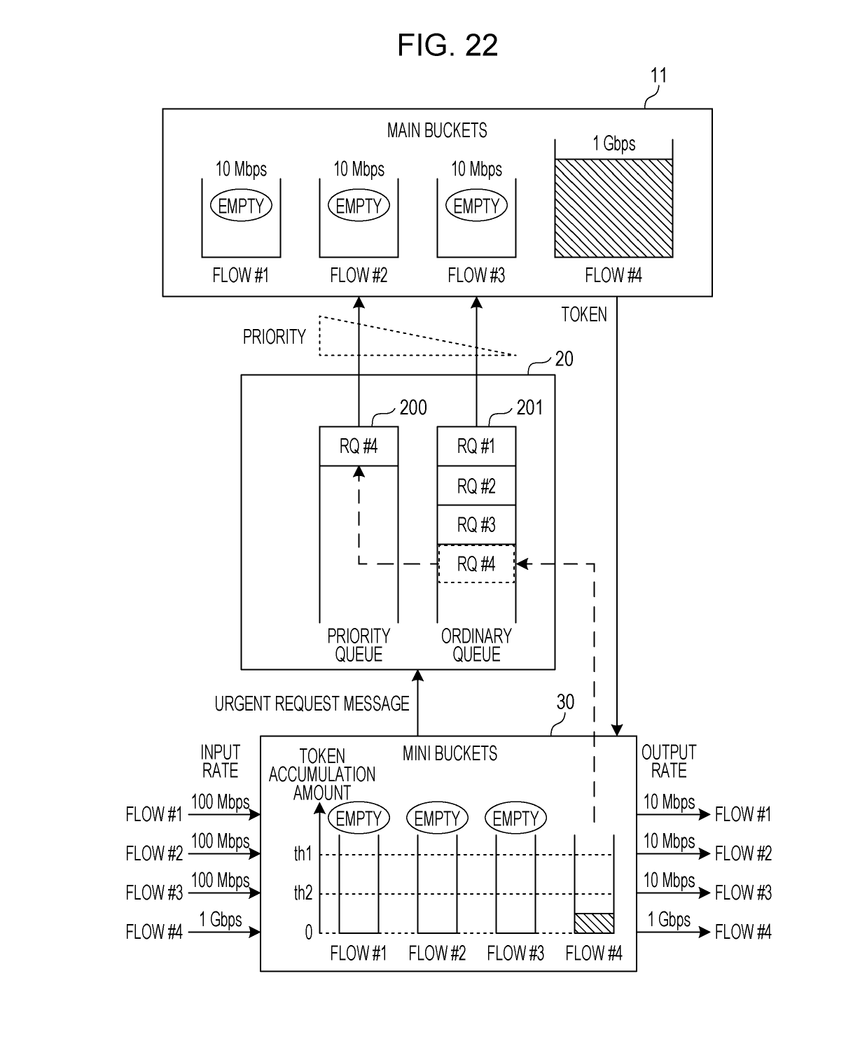

FIG. 22 illustrates the effects of the policer of the embodiments. FIG. 22 illustrates the configuration of FIG. 5 in a simplified manner such that it is possible to compare to the comparative embodiment of FIG. 4. In the same manner as in the comparative embodiment of FIG. 4, the policer of the present example has a mixture of bandwidth-exceeding flows #1 to #3 (100 Mbps), and a flow #4 (1 Gbps) within the agreed rate Ro in which the input rate R is higher than that of flows #1 to #3.

Since the mini buckets 30 of the flows #1 to #3 are depleted by the excess bandwidth, urgent request messages are output. However, since the input rates R of the flows #1 to #3 are greater than the agreed rates Ro, the urgent request messages of the flows #1 to #3 are not input to the priority queue 200. Therefore, the priority queue 200 does not become congested.

When the token accumulation amount in the mini buckets 30 of the flow #4 falls below the second threshold th2, the urgent request message of the flow #4 is output. Since the input rate R of the flow #4 is less than or equal to the agreed rate Ro, the urgent request message of the flow #4 is input to the priority queue 200 (refer to dotted line) instead of the ordinary queue 201.

At this time, since the priority queue 200 is not congested, the tokens of the main buckets 11 are quickly supplied to the mini buckets 30 of the flow #4 according to the urgent request message of the flow #4. Therefore, the tokens are supplied to the mini buckets 30 of the flow #4 so as to be in time for the passage of the packets, and packet discarding does not occur. Accordingly, since the output rate of the flow #4 is maintained at 1 Gbps which is the same as the input rate R, the agreed bandwidth of the flow #4 is guaranteed.

As described hereunto, the policer which is a bandwidth control device according to the embodiments includes the token controller 1, the pass controller 3, and the priority controller 2. The token controller 1 supplies tokens of packets according to requests. The pass controller 3 requests tokens of the token controller 1 for each of the flows, and controls the passage of the packets for each of the flows based on the tokens which are supplied according to the request.

The priority controller 2 compares the per-flow input rate R of the packets with the per-flow agreed rate Ro set, and, for each of the flows, controls the priority of requests to the token controller 1 according to the comparison results.

According to the configuration described above, the priority controller 2 is capable of setting the priority of requests of the flow in which the input rate R is less than or equal to the agreed rate Ro to a value which is higher than the flow requests in which the input rate R is greater than the agreed rate Ro. Accordingly, since the tokens are preferentially supplied to the flows in which the input rate R is less than or equal to the agreed rate Ro, the agreed bandwidth of the flows is guaranteed.

The bandwidth control method according to the embodiments includes the following operations.
Operation (1): request tokens for each flow of packets of the token controller 1 which supplies the tokens of the packets according to the requests.
Operation (2): control passage of packets for each of the flows based on the tokens which are supplied according to the requests.
Operation (3): compare the per-flow input rate R of packets with the agreed rate Ro which is set for each of the flows.
Operation (4): perform per-flow control of the priority of requests to the token controller 1 according to the comparison results.

Since the bandwidth control method according to the embodiments includes the same configuration as the bandwidth control device according to the embodiments, the same operational effects as those described above are obtained.

The embodiments described above are favorable exemplary embodiments. However, the configuration is not limited thereto, and various modified embodiments may be made without departing from the spirit and scope of the exemplary embodiment.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A bandwidth control device comprising:
a token controller configured to supply tokens of packets according to requests;
a pass controller configured to request the tokens of the token controller for each flow of packets, and control passage of the packets for each of flows based on an accumulation amount of the tokens supplied according to the requests; and
a priority controller configured to control priority of the requests to the token controller according to comparison results of an input rate of the packets for each of the flows with a predetermined value set for each of the flows.

2. The bandwidth control device according to claim 1,
wherein the priority controller sets the priority of the requests of the flow in which the input rate is less than or equal to the predetermined value to a value which is higher than the priority of the requests of the flow in which the input rate exceeds the predetermined value.

3. The bandwidth control device according to claim 1,
wherein the priority controller divides the priority of the requests into a plurality of levels corresponding to differences between the input rate and the predetermined value.

4. The bandwidth control device according to claim 1,
wherein the pass controller subtracts, every time a packet is passed, a length of the packet worth of an amount of the tokens from the accumulation amount of the tokens for each of the flows, and requests the tokens when the accumulation amount of the tokens fall below a predetermined first threshold and when the accumulation amount of the tokens fall below a predetermined second threshold which is smaller than the predetermined first threshold.

5. The bandwidth control device according to claim 4,
wherein the priority controller
sets the priority of the requests of the flow in which the accumulation amount of the tokens fall below the predetermined second threshold to a value which is higher than the priority of the requests of the flow in which the accumulation amount of the tokens fall below the predetermined first threshold, and
sets the priority of the requests of the flow in which the input rate is less than or equal to the predetermined value, of the flows in which the accumulation amount of the tokens fall below the predetermined second threshold, to a value which is higher than the priority of the requests of the flow in which the input rate exceeds the predetermined value.

6. The bandwidth control device according to of claim 4,
wherein the priority controller calculates the input rate based on a difference between the predetermined first threshold and the predetermined second threshold, and a time difference between a time at which the accumulation amount of the tokens fall below the predetermined first threshold and a time at which the accumulation amount of the tokens fall below the predetermined second threshold.

7. The bandwidth control device according to of claim 4,
wherein the priority controller calculates the input rate based on a difference in the accumulation amounts of the tokens between a time at which the accumulation amount of the tokens fall below the predetermined first threshold and a time at which the accumulation amount of the tokens fall below the predetermined second threshold, and a time difference between a time at which the accumulation amount of the tokens fall below the predetermined first threshold and a time at which the accumulation amount of the tokens fall below the predetermined second threshold.

8. The bandwidth control device according to claim 1,
wherein the priority controller calculates an average value of calculated input rates, and controls the priority of the requests according to the comparison results of the average value with the predetermined value.

9. The bandwidth control device according to claim 1,
wherein the pass controller discards packets based on the accumulation amount of the tokens, and
wherein the priority controller detects whether or not packets are discarded for each of the flows for each period from a request until a supply of the tokens in the pass controller, and controls the priority of the requests of the tokens to the token controller according to comparison results of detected number of discarded packets in a plurality of periods with a predetermined number for each of the flows.

10. A bandwidth control method comprising:
requesting tokens for each flow of packets;
controlling passage of the packets for each of flows based on an accumulation amount of the tokens supplied according to requests; and
controlling priority of the requests according to comparison results of an input rate of the packets for each of the flows with a predetermined value set for each of the flows.

11. The bandwidth control method according to claim 10,
the priority of requests of the flow in which the input rate is less than or equal to the predetermined value is set to a value which is higher than the priority of the requests of the flow in which the input rate exceeds the predetermined value.

12. The bandwidth control method according to claim 10,
wherein the priority of the requests is divided into a plurality of levels corresponding to differences between the input rate and the predetermined value.

13. The bandwidth control method according to claim 10,
wherein, every time a packet is passed, a length of the packet worth of an amount of the tokens are subtracted from the accumulation amount of the tokens for each of the flows, and the tokens are requested when the accumulation amount of the tokens fall below a predetermined first threshold and when the accumulation amount of the tokens fall below a predetermined second threshold which is smaller than the predetermined first threshold.

14. The bandwidth control method according to claim 13,
the priority of requests of the flow in which the accumulation amount of the tokens fall below the predetermined second threshold is set to a value which is higher than the priority of requests of the flow in which the accumulation amount of the tokens fall below the predetermined first threshold, and
the priority of requests of the flow in which the input rate is less than or equal to the predetermined value is set, of the flows in which the accumulation amount of the tokens fall below the predetermined second threshold, to a value which is higher than the priority of requests of the flow in which the input rate exceeds the predetermined value.

15. The bandwidth control method according to of claim 13,
wherein the input rate is calculated based on a difference between the predetermined first threshold and the predetermined second threshold, and a time difference between a time at which the accumulation amount of the tokens fall below the predetermined first threshold and a time at which the accumulation amount of the tokens fall below the predetermined second threshold.

16. The bandwidth control method according to of claim 13,
wherein the input rate is calculated based on a difference in the accumulation amount of the tokens between a time at which the accumulation amount of the tokens fall below the predetermined first threshold and a time at which the accumulation amount of the tokens fall below the predetermined second threshold, and a time difference between a time at which the accumulation amount of the tokens fall below the predetermined first threshold and a time at which the accumulation amount of the tokens fall below the predetermined second threshold.

17. The bandwidth control method according to claim 10,
wherein an average value of calculated input rate is calculated, and the priority of the requests is controlled according to the comparison results of the average value with the predetermined value.

18. The bandwidth control method according to claim 10,
wherein packets are discarded based on the accumulation amount of the tokens,
wherein whether or not packets are discarded for each of the flows for each period from a request until a supply of the tokens is detected, and
wherein the priority of requests of the tokens is controlled according to comparison results of detected number of discarded packets in a plurality of periods with a predetermined number for each of the flows.

19. A bandwidth control device comprising:
one or more hardware processors configured to
request tokens for each flow of packets;
control passage of the packets for each of flows based on an accumulation amount of the tokens supplied according to requests; and
control priority of the requests according to comparison results of an input rate of the packets for each of the flows with a predetermined value set for each of the flows.
